(19) United States
(12) Patent Application Publication
(10) Pub. No.: US 2010/0107812 A1
(43) Pub. Date: May 6, 2010

(54) Transmission

(76) Inventors: Ulrich Otten, Speyer (DE); Frank Buhrke, Weinheim (DE); Hannes Fischer, Berlin (DE)

Correspondence Address: DEERE & COMPANY, ONE JOHN DEERE PLACE, MOLINE, IL, 61265, US

(21) Appl. No.: 12/523,547

(22) PCT Filed: Jan. 17, 2008
(86) PCT No.: PCT/EP2008/050485

§ 371 Date: Jul. 17, 2009

(30) Foreign Application Priority Data
Jan. 17, 2007 (DE) 10 2007 003 340.2

(51) Int. Cl. F16H 37/04; B23P 11/00

(52) U.S. Cl. 74/745; 29/893.1

(57) ABSTRACT

The invention relates to a transmission (10) for transmitting a torque generated by a drive engine (74) to at least one drive axle (76, 78) of a vehicle (72). The vehicle (72) is in particular an agricultural or industrial utility vehicle. The transmission (10) comprises at least one main transmission unit (12) which can function independently. The main transmission unit (12) has a gear transmission and/or an auxiliary-range transmission. It is possible for an option transmission module (14) to be adapted onto the main transmission unit (12). It is possible by means of the option transmission module (14) to expand the functionality of the transmission (10). It is intended to specify and further develop a transmission (10) with which it is possible to provide, in particular from an economical aspect, a diverse range of transmissions for vehicles (72) of a series, and in which the installation space between the drive engine (74) and the main transmission unit (12) can be better utilized. According to the invention, the main transmission unit (12) and the option transmission module (14) are designed in such a way that the installation space provided for the transmission (10) is substantially unchanged even if the option transmission module (14) is adapted onto the main transmission unit (12). The present invention also relates to a main transmission unit (12), an option transmission module (14), a transmission type series, an agricultural or industrial utility vehicle (72) and a method for producing a transmission (10).

The invention relates to a transmission for transmitting a torque generated by a drive engine to at least one drive axle of a vehicle. The vehicle is in particular an agricultural or industrial utility vehicle, preferably a tractor. The transmission comprises at least one main transmission unit which can function independently. The main transmission unit has a gear transmission and/or an auxiliary-range transmission. It is possible for an option transmission module to be adapted onto the main transmission unit. It is possible by means of the option transmission module to expand the functionality of the transmission. The present invention also relates to a main transmission unit, an option transmission module, a transmission type series, an agricultural or industrial utility vehicle and a method for producing a transmission.

Within the context of the present invention, a functional transmission unit is to be understood to mean that a torque or rotational speed which is supplied to the transmission unit via an input interface is output again to an output interface of the transmission unit. Here, the transmission unit can have at least one shift point, so that the transmission unit can convert rotational speed, torque and/or rotational direction in at least two ratios/steps.

Transmissions of the type specified in the introduction are known from the prior art. A transmission from the Applicant, for example, in which an option transmission module is adapted onto a main transmission unit, is used in the mass production of tractors of the 6000 series. Said option transmission module is of modular design and can be composed in a versatile fashion according to the requirements of a customer. The option transmission module is arranged between the drive engine and the main transmission unit and requires a varying amount of installation space as a function of the respective composition of the option transmission module. At a full stage of expansion of the transmission, almost the entire installation space between the drive engine and the main transmission unit is taken up by the option transmission module. If the option transmission module has only one single functionality, the installation space between the drive engine and the main transmission unit is largely unutilized, since the same frame construction is used for all tractors of said series, and both the drive engine and the main transmission unit are always arranged substantially at the same position relative to the frame construction. The use of a frame construction therefore makes it possible inter alia for a tractor of a series or power class to be variably matched or configured to the respective customer requirements, as a result of which it is possible to provide, also from an economical aspect, a highly diverse range of transmissions for tractors of said series.

A disadvantage of this is however that, in said tractor series, it is necessary to always provide substantially the same installation space between the drive engine and the main transmission unit for all transmission variants, even though said installation space cannot be ideally utilized in the case of some transmission configurations—in particular those of a low stage of expansion. This can however result in further restrictions with regard to the chassis configuration of the tractor.

The present invention is therefore based on the object of specifying and further developing a transmission of the type specified in the introduction which serves to overcome the abovementioned problems. It is intended in particular to specify and further develop a transmission with which it is possible to provide, in particular from an economical aspect, a diverse range of transmissions for vehicles of a series, and which, when used in a vehicle, makes it possible for the installation space between the drive engine and the transmission to be better utilized.

The object is achieved according to the invention by means of the teaching of Patent claim 1. Further advantageous embodiments and developments of the invention can be gathered from the subclaims.

According to the invention, a transmission of the type specified in the introduction is characterized in that the main transmission unit and the option transmission module are designed in such a way that the installation space provided for the transmission is substantially unchanged even if the option transmission module is adapted onto the main transmission unit.

It should firstly be noted that, within the context of the present invention, the term “installation space” is to be understood in particular as the space or the volume which is taken up by the main transmission unit or by the housing of the main transmission unit.

According to the invention, the main transmission unit is designed in such a way that the option transmission module can be adapted thereon without a predefinable maximum installation space of the transmission, formed from the option transmission module and the main transmission unit, being exceeded, regardless of the embodiment or stage of expansion of the option transmission module. This could for example be achieved in that the option transmission module is always arranged spatially on or in the same predefined partial region of the transmission. Accordingly, the transmission or the main transmission unit is designed in such a way that it always makes available the installation space for the option transmission module. The transmission components of the main transmission unit could be designed or arranged in such a way that a torque flow can run for example from the main transmission unit to the option transmission module and back again into the main transmission unit. It is possible here for fixedly predefined interfaces to be defined by means of which the main transmission unit and the option transmission module can be coupled to one another and via which a torque can be transmitted. It is possible in particular for the components or the modular units of the transmission to be designed in such a way that the resulting torque flow is folded in on itself, that is to say runs in the transmission in one direction and at least once more in the opposite direction. In contrast thereto, in the transmissions known from the prior art, the torque flow runs in substantially one direction since, for each further option, a further option module is installed onto the transmission along said direction.

In this respect, the transmission according to the invention is characterized by a modular concept, and in using the transmission according to the invention, it is very particularly advantageously possible to always provide the same installation space for all transmission variants of a vehicle series, whereby the remaining installation space of the vehicles of the series can be utilized more effectively, for example by arranging a fuel tank between the drive engine and the transmission according to the invention. It would therefore be possible with regard to said example to always use the same fuel tank for all vehicles of the series, which permits more cost-effective production of the overall vehicle, since at least the modular units or components of the vehicle arranged around the transmission according to the invention are always of the same design and can therefore be purchased more cost-effectively in larger quantities.

In a preferred embodiment, the option transmission module has at least one option unit. An option unit can for example be designed in the form of at least one clutch unit. Said clutch unit could comprise a frictionally-engaging (asynchronous) clutch, by means of which the torque flow between the drive engine and the transmission—in concrete terms, the option transmission module—can be interrupted.

In addition, the option transmission module could have an option unit which is designed in the form of a reversing unit. The latter can be used to provide a rotational direction reversal, which is provided in particular in agricultural and industrial utility vehicles or tractors since vehicles of said type frequently change their direction of travel during operation.

Tractors in particular conventionally have a creep gear unit, with which the tractor can transmit a high torque power into the underlying surface of the vehicle at a low locomotive speed, for example when cultivating. A creep gear unit of said type could also be designed in the form of an option unit which can be integrated into the option transmission module.

It is also conceivable to provide a two-stage transmission unit (High-Low) as an option unit. An option unit of said type permits in particular a direct shift from a high rotational speed, as is for example required in a tractor when travelling at high speed on a road, to a low rotational speed, as is for example required when the tractor is used to carry out field work. The two-stage transmission unit could be designed such that it can be shifted in a form-fitting or force-fitting manner—in particular under load.

In a very particularly preferred embodiment, the option transmission module has a base housing part. A base housing part of said type could be designed in such a way that at least one option unit can be adapted thereon. The clutch unit is preferably adapted onto the base housing part of the option transmission module, since the clutch unit is used to introduce the torque output by the drive engine into the transmission, which, in a very particularly preferred embodiment of the transmission according to the invention, is the case in all of the differently-configurable main transmission units together with option transmission modules.

For simple and time-saving assembly of the option transmission module on the main transmission unit, the base housing part of the option transmission module could have at least one positioning means. A further positioning means which is of substantially complementary design to said positioning means could be provided on the main transmission unit and/or on a transmission housing. The positioning means and the further positioning means would then have to be arranged in such a way that the option transmission module can be positioned or aligned, with regard to its spatial position and/or orientation, relative to the main transmission unit when the positioning means come into contact with one another. It would thus for example be possible to provide, as a positioning means, at least one reference face on the housing of the main transmission unit, for example at a housing opening, in relation to which reference face, on the one hand, bearing points or guide bores of the main transmission unit are aligned or relatively positioned during production of the transmission, and in relation to which reference face, on the other hand, positioning can take place in the adaptation of the option transmission module. Accordingly, the positioning means could have at least one pin, at least one stop face and/or at least one edge. It is advantageously generally possible to avoid long-winded adjustment of the components by means of said measure.

An option unit of the option transmission module could have a housing part. The housing part could serve to rotatably mount at least one shaft. The housing part could also have a bearing support, which could thus come into contact with at least one housing wall of the option transmission module or with at least one housing wall of the main transmission unit. The housing part could form a transmission oil port to a housing wall and/or to a transmission cover of the main transmission unit. The corresponding option unit could be lubricated via a transmission oil port of said type and/or the transmission oil port could serve for the hydraulic actuation of any provided shift components of the option unit. The housing part could likewise have a duct via which transmission oil or hydraulic fluid can be conducted to a hydraulically actuable shift element.

It is very particularly preferable for the option transmission module to be designed in such a way that different options of the option transmission module can be constituted by means of a modular, cumulative adaptation of a plurality of option units together with housing parts or bearing supports. This could be provided by virtue of the respective housing parts of the respective option units being mounted on one another, whereby in particular the functionality of the option transmission module can be expanded. The option transmission module together with the option units which form the option module is also accordingly designed in such a way that all the expediently providable options of the option transmission module altogether do not exceed a maximum predefinable installation space, so that the options can be adapted onto the main transmission unit. In concrete terms, a first option unit of the option transmission module is adapted onto the base housing part. A further housing part of a further option unit is then adapted onto the base housing part, and so on.

It is very particularly preferable for the respective shafts of the individual option units to be arranged substantially coaxially with respect to one another in the assembled state. It would thus be possible, for example, to provide a hollow shaft and an inner shaft arranged therein, or two shafts which are arranged in series in the direction of the rotational axis. Shafts of the individual option units which are arranged parallel to one another are particularly preferable.

In a very particularly preferred embodiment, a transmission housing is provided which holds the main transmission unit. The transmission housing could be designed in such a way that the option transmission module can be at least largely mounted in the transmission housing. For this purpose, the transmission could expediently have an opening into which the option transmission module can be inserted. Said opening could be closed off or sealed off with a lid or with a housing covering which could be provided on the option transmission module in order to seal off the transmission. Regardless of whether or not an option transmission module is adapted onto the main transmission unit, and/or regardless of the stage of expansion of the option transmission module, the transmission housing together with the cover, or together with the adapted option transmission module and housing cover for the latter, always has substantially the same installation space.

The transmission housing can be of single-part or multi-part design. A transmission housing of single-part design is to be understood to mean in particular that the housing section which surrounds the main transmission unit and the option transmission module is produced from one part, for example could be produced from a casting. In this case, the transmission housing will have an opening which can be closed off with a lid. Here, although the transmission housing is then formed overall by the housing section, which surrounds the main transmission unit and the option transmission module, and the lid, this should nevertheless be interpreted as a transmission housing of single-part design. The lid closes off the transmission housing to the outside, but without accommodating components of the transmission. The transmission housing accommodates components of the transmission. The components of the main transmission unit and of the option transmission module can be mounted and/or serviced or repaired through the opening of the transmission housing. As an alternative to a transmission housing of single-part design, said transmission housing can also be of two-part or multi-part design. The transmission housing could thus for example be composed of two parts of substantially the same size, with the transmission housing composed in this way holding or at least largely surrounding both the main transmission unit and also the option transmission module, and with it being possible if appropriate for the transmission housing composed in this way to be closed off by means of a cover. The transmission housing could also be composed of two parts, with the one housing part holding or at least largely surrounding the main transmission unit and with the other housing part holding or at least largely surrounding the option transmission module. It is possible in this way to permit simple production or assembly of the transmission. When the two housing parts are mounted on one another, the transmission is at least largely assembled and is fundamentally operational. The transmission housing composed of the two housing parts could also be closed off by means of a lid.

If appropriate, the option transmission module which is adapted onto the main transmission unit or into the transmission housing could project partially out of the transmission housing. With a transmission housing of single-part design, it is for example possible for the main transmission to be fully mounted into the transmission housing and, if appropriate, to be checked in terms of operation. The option transmission module can be adapted retrospectively without it being necessary to re-check the main transmission unit in terms of operation. In order to adapt the option transmission module, it is not necessary to dismantle the main transmission unit or the housing; it is merely necessary to remove the cover—which is preferably arranged on an upper region—and to insert the option transmission module. Transmission oil which remains in the transmission housing following any preceding operational check is thereby very particularly advantageously not unnecessarily lost. It could be possible to produce a torque flow indirectly or directly between the option transmission module and the main transmission unit for example by means of a shaft/hub connection or by means of the clutch unit of the option transmission module. The transmission according to the invention could be checked in terms of operation thereafter.

A pump drive for transmission oil, a rear axle differential gearing, an interface for a mechanical individual wheel drive and/or an intermediate axle differential gearing can preferably be adapted into or onto the transmission housing. The transmission housing accordingly has corresponding fastening points, flanges or the like. The rear axle differential gearing is preferably arranged laterally in a state in which the transmission is installed on the vehicle, and can extend at least partially into the transmission housing, with it being possible for an output shaft of the main transmission unit to directly transmit mechanical power to the rear axle differential gearing.

In a preferred embodiment of the transmission according to the invention, the option transmission module is designed in the form of a transmission which is self-contained or can function independently. The option transmission module could thus for example have a separate oil pump and/or at least one separate actuating device—for example for actuating at least one clutch of the option transmission module by means of hydraulic shift elements. In such a case in particular, it can be expedient for the option transmission module to have a largely closed-off option transmission module housing.

In order that a torque flow is possible between the main transmission unit and the option transmission module, the option transmission module can preferably be adapted onto the main transmission unit by means of a shaft/hub connection. Said shaft/hub connection is preferably of reversible design, and can thus be retrospectively released again for example in order to dismount the option transmission module from the main transmission unit for servicing purposes or in order to retrospectively adapt another option transmission module onto the main transmission unit. In concrete terms, the shaft/hub connection could be designed to be torque-resistant in a form-fitting or force-fitting manner.

As already indicated in connection with the shaft/hub connection, the option transmission module could be reversibly adaptable into or onto the main transmission unit for example in order to be able to retrospectively dismount the option transmission module from the main transmission unit.

The main transmission unit could fundamentally be designed in the form of a continuously variable transmission or a transmission having discrete shift stages. The main transmission unit is preferably a transmission having discrete shift stages. Even for the latter, it is possible to provide differently-designed main transmission units. It is thus for example conceivable to provide main transmission units which have 9 forward and 3 reverse gears (as 3 gears times 3 groups), 8 forward and 4 reverse gears (as 4 gears times 2 groups), 12 forward and 4 reverse gears (as 3 gears times 4 groups), 12 forward and 4 reverse gears (as 4 gears times 3 groups), or 16 forward gears (as 4 gears times 4 groups).

In concrete terms, the main transmission unit is embodied as a three-shaft transmission. The three transmission shafts are arranged substantially parallel to one another in the main transmission unit. The main transmission unit could have an input shaft, an intermediate shaft and an output shaft. The input shaft is preferably designed in the form of a hollow shaft. Here, the transmission can be configured in such a way that a torque flow takes place from the input shaft to the output shaft via the intermediate shaft (two gearwheel engagements) or from the input shaft directly to the output shaft (one gearwheel engagement).

The force transmission within the transmission is usually conducted via gearwheel pairs which are in each case arranged on two transmission shafts and which have a fixedly predefined axis spacing relative to one another. In order that a transmission is of the smallest possible dimensions for a certain power class, the axes of the input and output shafts—in particular in tractors—have hitherto been arranged vertically in relation to one another. This is done inter alia because, in tractors, the position of the power take-off shaft stub is predefined by various standards, and a favourable design of the power take-off drive train is possible in this way. In said configuration, the speed transformation from the drive engine to the power take-off shaft stub is carried out with only one gearwheel engagement.

In a particularly preferred embodiment of the transmission according to the invention, the main transmission unit is designed in such a way that, in a state in which the main transmission unit is installed in a vehicle, the position of the output shaft is arranged so as to be offset in the horizontal direction and if appropriate in the vertical direction in relation to the position of the input shaft. This has the result that, under some circumstances, the main transmission unit is of dimensions which are not as small as in the case of the abovementioned two-shaft transmissions which are known from the prior art. This does however have the result that the transmission can be installed flatter in the vehicle, so that for example also the drive engine of the vehicle and its drive output shaft can be arranged lower in relation to the chassis. This has the result that the engine hood of the vehicle can likewise be arranged lower, which therefore advantageously permits improved visibility conditions. This also makes it possible to dispense with the so-called transmission tunnel which was hitherto provided in cabins or on operator platforms of tractors and which have considerably restricted the freedom of movement in the leg region of the operator.

In addition or alternatively, the main transmission unit is designed in such a way that, in a state in which the main transmission unit is installed in a vehicle, the position of the intermediate shaft is arranged so as to be offset in the vertical direction in relation to the position of the output shaft and/or to the position of the input shaft. It is also conceivable for the main transmission unit to be designed in such a way that, in a state in which the main transmission unit is installed in a vehicle, the position of the intermediate shaft is arranged so as to be offset in the horizontal direction in relation to the position of the input shaft and/or to the position of the output shaft. In other words, the three shafts of the main transmission unit are arranged in a triangular configuration, wherein the input shaft could be arranged in the vertical direction above the output shaft, but with a smaller height difference relative to the output shaft than has hitherto been conventional.

The input shaft and also the output shaft is in each case equipped with gearwheels and further transmission elements. In order that different transmission ratios of the main transmission unit can be set during operation, the input shaft and/or the output shaft has in each case at least one shift device. The latter could for example be a shift element for actuating an in hydraulic clutch. In said case, the shift elements could for example be a hydraulic line, a shift fork, at least one guide rod and a shift sleeve. Using pressurized liquid, the shift fork which is guided on the at least one guide rod could be moved in such a way that, in this way, a shift sleeve is possible for producing, shifting and/or releasing a rotationally fixed connection between a gearwheel, which is arranged on the respective shaft, and the shaft. The liquid could be conducted by means of the hydraulic line to the shift fork or to a corresponding actuating element (for example a piston). A shift device of the type described immediately above will conventionally provide a form-fitting, synchronized shift point. It is however also conceivable for a shift device to be shifted in a frictionally-engaging, that is to say unsynchronized manner.

The main transmission unit is now designed in such a way that it is possible, as a function of the shift states of the provided shift devices, to produce a torque flow from the input shaft to the output shaft via the intermediate shaft, or from the input shaft directly to the output shaft. Accordingly, a torque can be transmitted with the main transmission unit by means of two or three gearwheel trains or gearwheel engagements.

In a very particularly preferred embodiment of the main transmission unit, it is provided that, where the individual transmission shafts of the main transmission unit are equipped differently for transmissions with different properties, the corresponding shift devices are arranged in each case at the same position. It is also possible for at least one bearing point of a transmission shaft to be arranged in each case at the same position even where a main transmission unit is equipped differently for transmissions with different properties. If, therefore, the main transmission unit has 9 forward and 3 reverse gears, the shift points required for this and the bearing points for the three shafts of the main transmission unit are provided at a certain point of the main transmission unit. If a main transmission unit now has 16 forward and 4 reverse gears, the shift points required for this and the bearing points of the three shafts of the main transmission unit are arranged at substantially the same point as is the case in the transmission unit with 9 forward and 3 reverse gears. It is hereby possible in a very particularly advantageous way to provide a multiplicity of differently configurable main transmission units using otherwise substantially unchanged components, for example the housing of the main transmission unit or the shift points themselves. It is thus possible with said measure to provide a diverse range of transmissions even from an economical aspect.

It is expedient in particular for transmissions which are used in agricultural vehicles to arrange the gearwheels and at least one shift device for the gear transmission on the input shaft of the main transmission unit. Accordingly, gearwheels and at least one shift device for an auxiliary-range transmission are arranged on the output shaft of the transmission unit.

In one embodiment of the transmission according to the invention, the main transmission unit is designed in such a way that all of the axis spacings between the three transmission shafts have in each case substantially the same value. It is however preferably provided that, in the main transmission unit of a transmission according to the invention, at least two—preferably all three—axis spacings between the three transmission shafts have in each case different values. It is possible in this way to obtain both favourable transmission ratios and also high levels of efficiency of the main transmission unit.

In a very particularly preferred embodiment, the housing of the main transmission unit or the main transmission unit has a housing opening which serves for mounting the option transmission module. For mounting, the option transmission module is inserted into the housing opening. The housing opening is preferably designed so as to interact with the option transmission module in such a way that the option transmission module, in a state installed in the housing opening, can be displaced in at least one direction relative to the main transmission unit in order to produce a shaft/hub connection between the main transmission unit and the option transmission module. It is very particularly advantageously possible in this way for the option transmission module to be mounted on the main transmission unit in a quick and uncomplicated fashion. In the same way, it is possible for the option transmission module to be dismounted for example for servicing purposes or for a retrospective change of the transmission properties.

The following text describes an embodiment of the transmission according to the invention, or an arrangement of the transmission according to the invention in a vehicle, which is suitable in particular for tractors. Accordingly, the main transmission unit is arranged in the spatial surroundings or vicinity of a drive axle of the vehicle, which is conventionally the rear axle in tractors. The term “spatial vicinity” could be understood to mean half of the wheel spacing, for example. It is possible for the drive axle to be at least partially driven with the torque output at the drive output side by the main transmission unit together with any option transmission module which may be adapted.

It is very particularly preferable that, with regard to a longitudinal axis of the drive axle of the vehicle, the main transmission unit and/or the option transmission module is arranged spatially behind the axle differential gearing. In other words, the main transmission unit and/or the option transmission module is arranged adjacent to the axle differential gearing, with the axle differential gearing being arranged in said embodiment not in the center of the vehicle axis, as is conventional, but laterally adjacent to one of the wheels of the axle. The half transmission unit and/or the option transmission module is therefore arranged in a central region of the respective vehicle axle or extends at least into said region. It can however be provided here that a driveshaft of said vehicle axle extends through the main transmission unit or through its housing. Although the main transmission unit can if appropriate be arranged, directly adjacent to the differential gearing, it is not necessary for the main transmission unit to be in a direct torque flow with the latter. It is also entirely conceivable for a drive output shaft of the option transmission module to be in a direct torque flow with the axle differential gearing. In a preferred embodiment, a drive output shaft of the main transmission unit is drive-connected to the axle differential gearing. On account of the adjacent arrangement of the main transmission unit and/or of the option transmission module and of the axle differential gearing, the transmission components of the vehicle are concentrated in the spatial region of the drive axle of the vehicle, so that in a very particularly advantageous way there is now installation space available in a region between the drive axle and a further vehicle axle and/or the drive engine in this embodiment, which installation space can be utilized for other vehicle components.

In a likewise preferred embodiment, the main transmission unit, together with any option transmission module which may be adapted thereon, is or are designed in such a way that, in a state in which the main transmission unit is installed in a vehicle, the option transmission module is arranged spatially adjacent to the axle differential gearing. A configuration of said type could, in concrete terms, be designed in such a way that, at the level of the drive axle, the axle differential gearing and the option transmission module are arranged adjacent to one another or in series in the direction of the longitudinal axis of the drive axle. The main transmission unit is then arranged in a region directly in front of or behind the drive axle as viewed in the vehicle longitudinal direction. Depending on how the transmission according to the invention is designed in concrete terms, either the main transmission unit or the option transmission module is in a direct torque flow with the axle differential gearing of the drive axle.

It is fundamentally provided that it is possible to realize a torque flow from the drive engine to the drive axle of the vehicle via the main transmission unit. In concrete terms, it could be possible to realize a torque flow from the drive engine to the drive axle of the vehicle via the option transmission module and via the main transmission unit in said sequence. The main transmission unit and the option transmission module are to be designed correspondingly for this purpose.

In a very particularly preferred embodiment, an axle differential gearing is connected downstream of the main transmission unit. The connection downstream relates in particular to the spatial arrangement of the main transmission unit relative to the axle differential gearing, and to the torque flow between the main transmission unit and the axle differential gearing. The axle differential gearing is designed in such a way that at least part of the power—torque or rotational speed—output by the main transmission unit can be transmitted by means of said axle differential gearing to the drive wheels of the corresponding drive axle. Usually, almost the entire power output by the main transmission unit is transmitted to the drive wheels of the drive axle. If, however, part of the power output by the main transmission unit is transmitted to a further drive axle of the vehicle, only the remaining part is transmitted to the drive wheels of the drive axle connected downstream of the axle differential gearing.

If the vehicle has more than one drive axle, provision is made in one embodiment of a transmission interface, by means of which at least part of the power supplied to the main transmission unit can be transmitted via a further drive output shaft to a further drive axle of the vehicle. The further drive axle can likewise have an axle differential gearing. If the vehicle is a tractor, the primary drive axle is the rear axle. The further drive axle is accordingly the front axle of the tractor. A predefinable proportion of the torque provided by the drive engine of the tractor to the rear axle is transmitted to the further drive axle, and a further predefinable proportion is transmitted to the front axle of the tractor, as a function of the operating state of the tractor. The ratio of the torque proportions which are transmitted to the two vehicle axles could be substantially constant at all times.

Aside from the fact that the transmission interface could be designed to be operable in such a way that a torque flow to the further drive axle can be activated and deactivated, in a particularly preferred embodiment, the transmission interface can be operated and/or is designed in such a way that the ratio of the torques which can be output to the drive axle and to the further drive axle is variable. Accordingly, the transmission interface can be operated as a mid-axle differential gearing. It is very particularly preferable for the torques transmitted to the two drive axles to be substantially in a ratio of 60:40, that is to say 60 percent of the torque is transmitted to the rear axle and 40 percent can be transmitted to the front axle of the vehicle, which is expedient in a tractor.

In order that the vehicle having the transmission according to the invention can be used in a diverse range of ways, in one preferred embodiment, the main transmission unit has a further mechanical interface which serves for transmitting mechanical torque from the main transmission unit and/or from the option transmission module and/or from the drive engine to a working implement which can be adapted onto the vehicle. An interface of said type can be designed in the form of a power take-off shaft and can accordingly be compatible with working implements used in the agricultural field. It is preferably provided that a torque flow takes place from the drive engine directly to the power take-off shaft, with it being possible to provide a power take-off shaft gearing with which it is possible to provide the conventionally used rotational speeds of the power take-off shaft. Although the torque flow takes place from the drive engine directly to the power take-off shaft, a corresponding shaft could extend through the main transmission unit and/or the option transmission module.

In one preferred embodiment, the main transmission unit or the option transmission module can be connected to the drive engine by means of a torsion shaft. Accordingly, the housings of the drive engine and of the transmission according to the invention can be formed separately from one another, that is to say need not be combined in one housing block. Said torsion shaft is preferably designed, with regard to its dimensions or with regard to its properties, in such a way that at least one—preferably the first or lowest—natural frequency of the entire transmission does not lie within the natural frequency range of the utilizable rotational speed band. If a torsion shaft of said type is used, it is possible to dispense with a torsional vibration damper or torsional vibration absorber arranged between the drive engine and the transmission, so that it is particularly advantageously possible to reduce the number of components and the costs for this purpose.

As an alternative to this, the main transmission unit or the option transmission module could be connected to the drive engine by means of a driveshaft, with a torsion element preferably being provided between the main transmission unit and the drive engine. Here, the driveshaft is not designed to dampen torque peaks between the drive engine and the transmission, since the torsion element is provided for this purpose, which torsion element can be designed in the form of a torsional vibration damper or torsional vibration absorber.

In a very particularly preferred embodiment, it is possible to produce a torque flow between the drive engine and the main transmission unit via the torsion shaft or via the driveshaft by means of the clutch unit of the option transmission module. It is therefore possible for a torque flow between the drive engine and the transmission, or option transmission module, according to the invention to be interrupted by means of the clutch unit. When the clutch unit is engaged, a torque flow is produced between the drive engine and the option transmission module. The torque output by the option transmission module to the main transmission unit is then transmitted via the axle differential gearing to the wheels of the vehicle.

The transmission according to the invention is very particularly preferably used for a tractor. In said case in particular, the gear transmission or the auxiliary-range transmission of the main transmission unit is embodied as a power-shift transmission, so as to permit both a high transmission spread, as is required for a tractor, and also shifting under load.

With regard to a main transmission unit, the object specified in the introduction is achieved by means of the features of claim 36. According to said claim, a main transmission unit for an agricultural or industrial utility vehicle is characterized by a design which is such that an option transmission module according to one of claims 1 to 35 can be adapted onto the main transmission unit. In this respect, the main transmission unit has installation space in or on which the option transmission module is adapted onto the main transmission unit, so that the installation space provided for the main transmission unit remains substantially unchanged even when the option transmission module is adapted onto the main transmission unit. In the same way, with regard to an option transmission module, the object specified in the introduction is achieved by means of the features of claim 37. According to said claim, an option transmission module for a transmission for an agricultural or industrial utility vehicle is characterized by a design which is such that the option transmission module can be adapted onto a main transmission unit according to one of claims 1 to 35. Since either the main transmission unit or the option transmission module is in each case designed in such a way that it can be adapted onto the in each case other element, reference is made to the preceding part of the description in order to avoid repetition.

With regard to a transmission type series, the object specified in the introduction is achieved by means of the features of Patent claim 38. According to said claim, the transmission type series is formed from differently-designed transmissions according to one of claims 1 to 35. Different transmissions can be formed by adapting different option transmission modules onto a main transmission unit and/or in that the main transmission unit can be designed differently. The transmission type series is preferably configured for agricultural or industrial utility vehicles, in particular for tractors. According to the invention, it is possible to provide a diverse range of transmission in that differently-designed option transmission modules can be adapted onto one type of main transmission unit. As already described, different option transmission modules can be formed for example by means of a cumulative adaptation of a plurality of option units. As an alternative or in addition, a diverse range of transmission can also be provided by means of differently-designed main transmission units, which is discussed in the following.

The main transmission unit could for example be designed differently in that the input shaft, the intermediate shaft and/or the output shaft are equipped with different gearwheels. Different main transmission units can thus have for example 9 forward and 3 reverse gears or 12 forward and 4 reverse gears, as already described.

Only one type of housing is therefore always nevertheless used for the main transmission unit, and in a preferred embodiment, it is provided that, where the individual transmission shafts of the main transmission unit are equipped differently, the corresponding shift devices are preferably arranged in each case at the same point or spatial position. With said measure, it is logically also possible to retrospectively change the properties of the main transmission unit, for example if a vehicle equipped with a transmission according to the invention must satisfy new or changed demands. For this purpose, however, the main transmission unit would require to be dismantled and equipped differently—for example with other gearwheels.

It is preferably the case that, where main transmission units are designed differently, the bearing points of a transmission shaft are arranged in each case at the same point or spatial position even where a transmission shaft of the main transmission unit is equipped differently. As a result of said measure, it is possible to always use the same housing for the main transmission unit, which particularly advantageously permits a large number of different transmissions to be provided in an economical way.

In a very particularly preferred embodiment, different transmission power classes can be formed in that the axis spacing between the input shaft and the intermediate shaft and the axis spacing between the intermediate shaft and the output shaft are varied among different main transmission units, with the ratio of the two axis spacings, on the one hand between the input shaft and the intermediate shaft and on the other hand between the intermediate shaft and the output shaft, remaining substantially constant. For this purpose, it is necessary to provide different housings for main transmission units for different transmission power classes, since the axis spacings of the input shaft and of the output shaft and therefore the bearing points for said shafts are to be varied. Under some circumstances, however, for different housings of the main transmission units, it is possible for the shift devices provided in each case to be arranged in each case at the same points or spatial positions.

As already indicated, the transmission according to the invention according to one of claims 1 to 35 is very particularly preferably used for an agricultural or industrial utility vehicle, and in particular for a tractor.

With regard to a method, the object specified in the introduction is achieved by means of the method steps of the production method according to claim 43. According to said claim, the method according to the invention for producing a transmission according to one of claims 1 to 35 is characterized in that the option transmission module is mounted on the main transmission unit of the transmission in such a way that the option transmission module is inserted into a housing opening of the main transmission unit. The option transmission module is displaced along at least one direction in such a way that a shaft/hub connection is produced between the option transmission module and the main transmission unit. The option transmission module is fixed to the main transmission unit, specifically preferably to the housing of the main transmission unit. A pre-requirement for the application of the production method according to the invention is a corresponding design of the main transmission unit and of the option transmission module, specifically such that, on the one hand, the option transmission module can be moved or displaced along at least one direction in the housing opening of the main transmission unit. On the other hand, an interface in the form of a shaft/hub connection is provided between the main transmission unit and the option transmission module, which shaft/hub connection can be produced by means of a displacement of the option transmission module relative to the main transmission unit.

As already mentioned, different option transmission modules are provided which can be adapted onto the main transmission unit. According to one preferred embodiment, a plurality of option units can be assembled to form an option transmission module by virtue of in each case one option unit being fastened with its base housing part to a base housing part of another option unit. It is hereby very particularly advantageously possible for different option transmission modules to be produced modularly and cost-effectively, with always substantially identically-designed individual components or base housing parts, without it being necessary to provide in each case one separate, under some circumstances complex overall housing for each differently-designed option transmission module.

There are now various possibilities for the advantageous embodiment and further development of the teaching of the present invention. In this regard, reference is made on the one hand to the patent claims which are subordinate to the further independent patent claims, and on the other hand to the following explanation of the preferred exemplary embodiments of the invention on the basis of the drawing.

Generally preferred embodiments and further developments of the teaching are also explained in connection with the explanation of the preferred exemplary embodiments of the invention on the basis of the drawing. In the drawing, in a schematic illustration in each case:

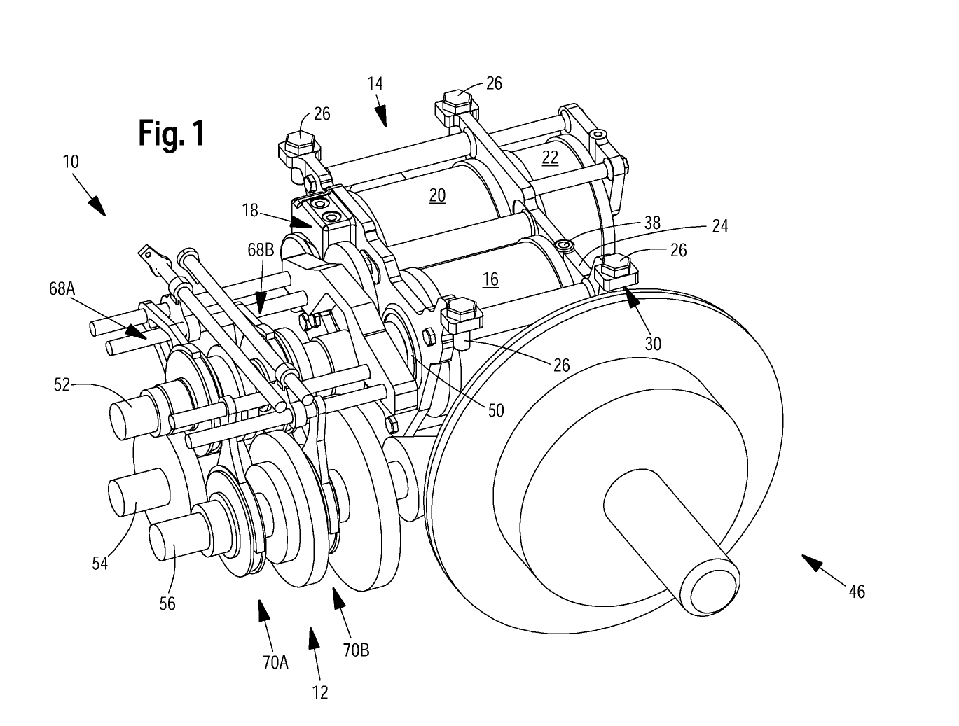

FIG. 1 shows a perspective view of a first exemplary embodiment of a transmission according to the invention,

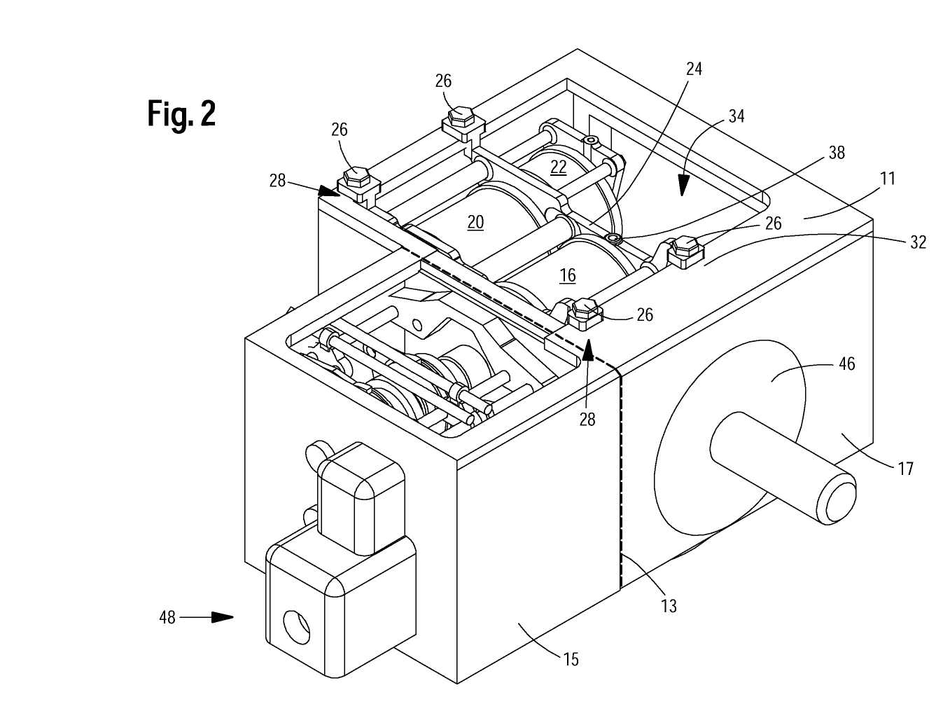

FIG. 2 shows a perspective view of the transmission from FIG. 1 in a transmission housing provided for this purpose,

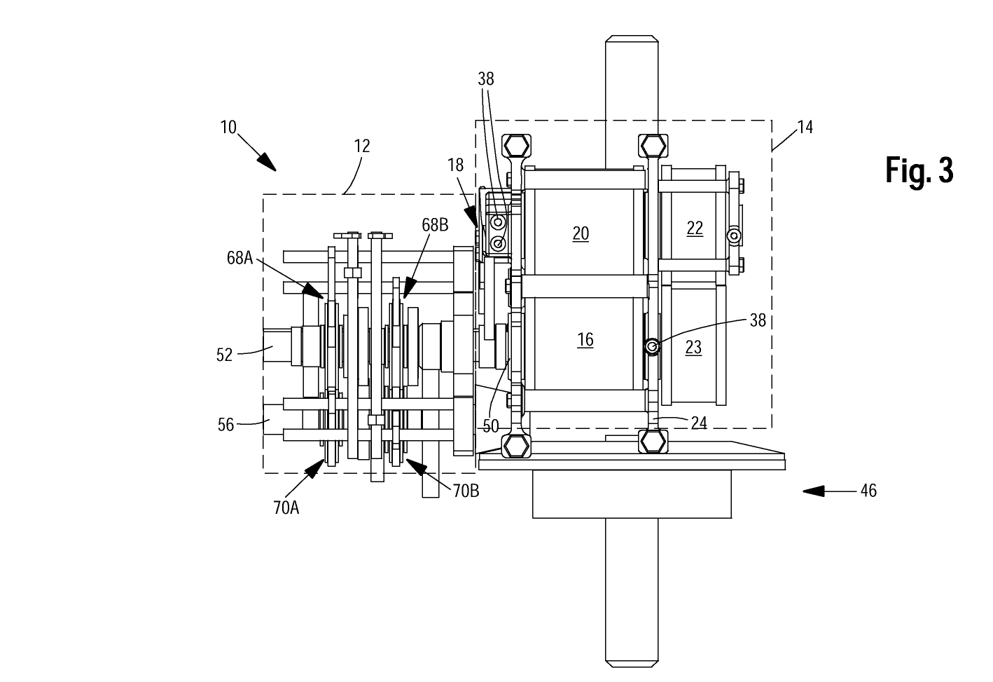

FIG. 3 shows a perspective plan view of a second exemplary embodiment of a transmission according to the invention,

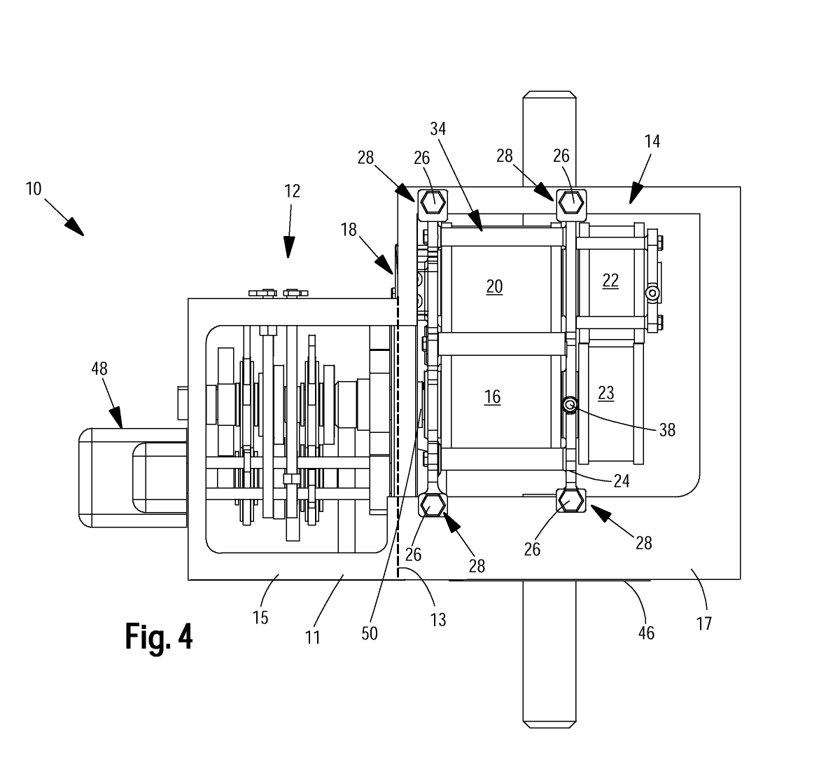

FIG. 4 shows a perspective view of the transmission from FIG. 3 in a transmission housing provided for this purpose,

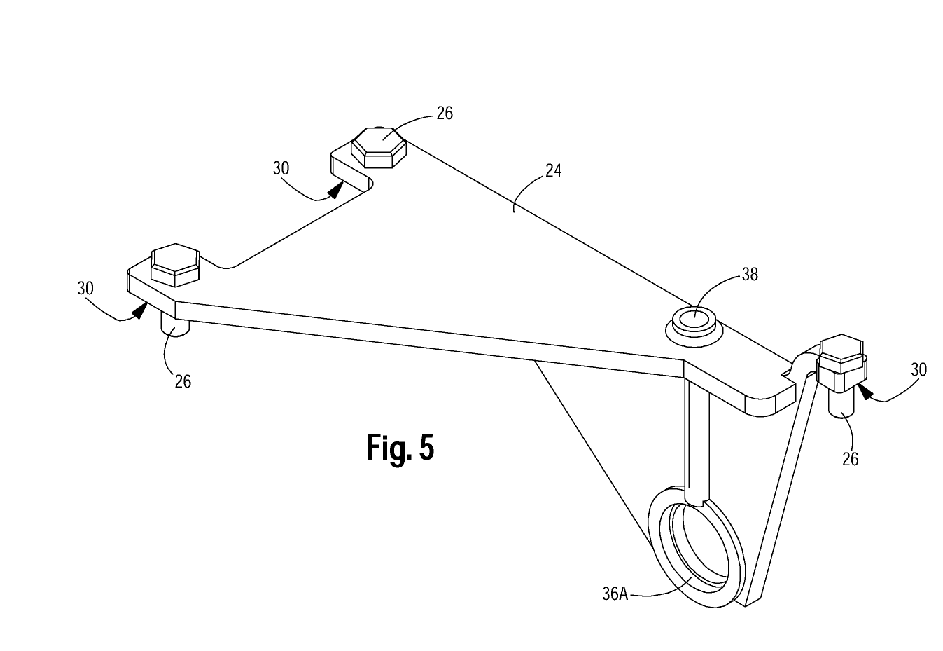

FIG. 5 shows a perspective view of a housing part of an option unit of the option transmission module in a first stage of expansion,

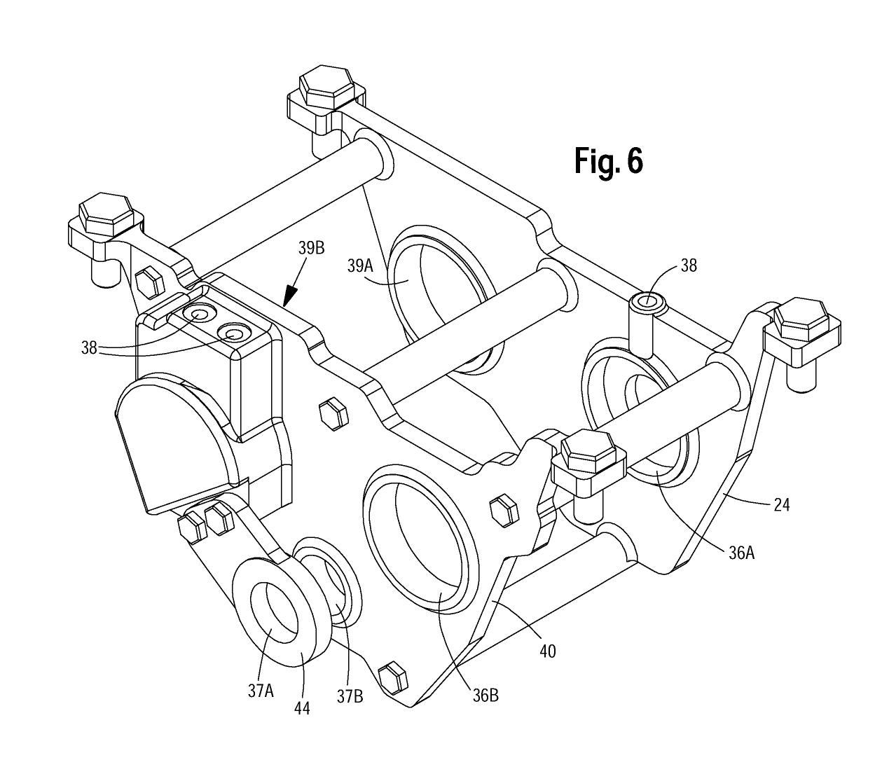

FIG. 6 shows a perspective view of a plurality of housing parts, which are assembled on one another, of option units of the option transmission module in a second stage of expansion,

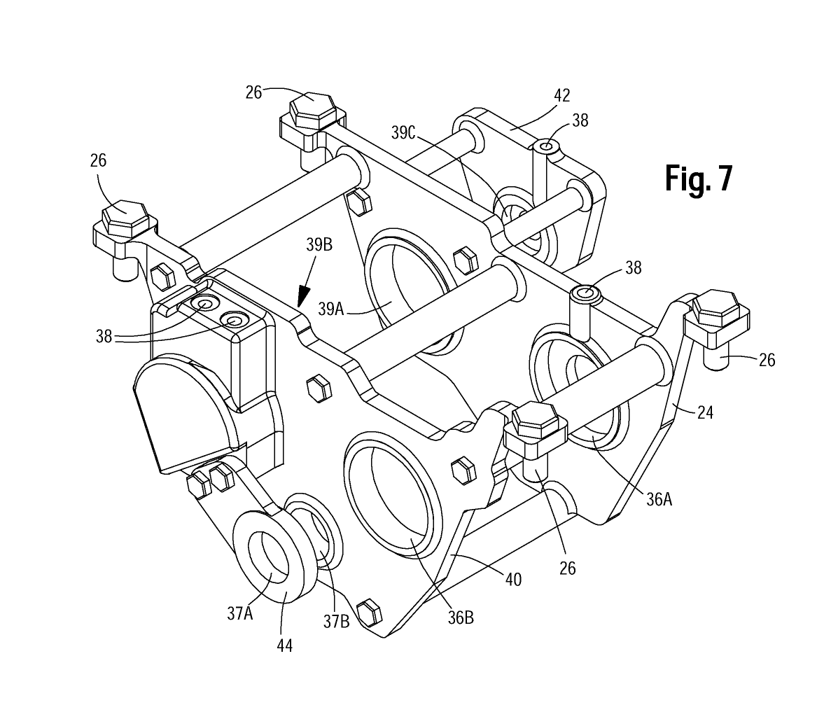

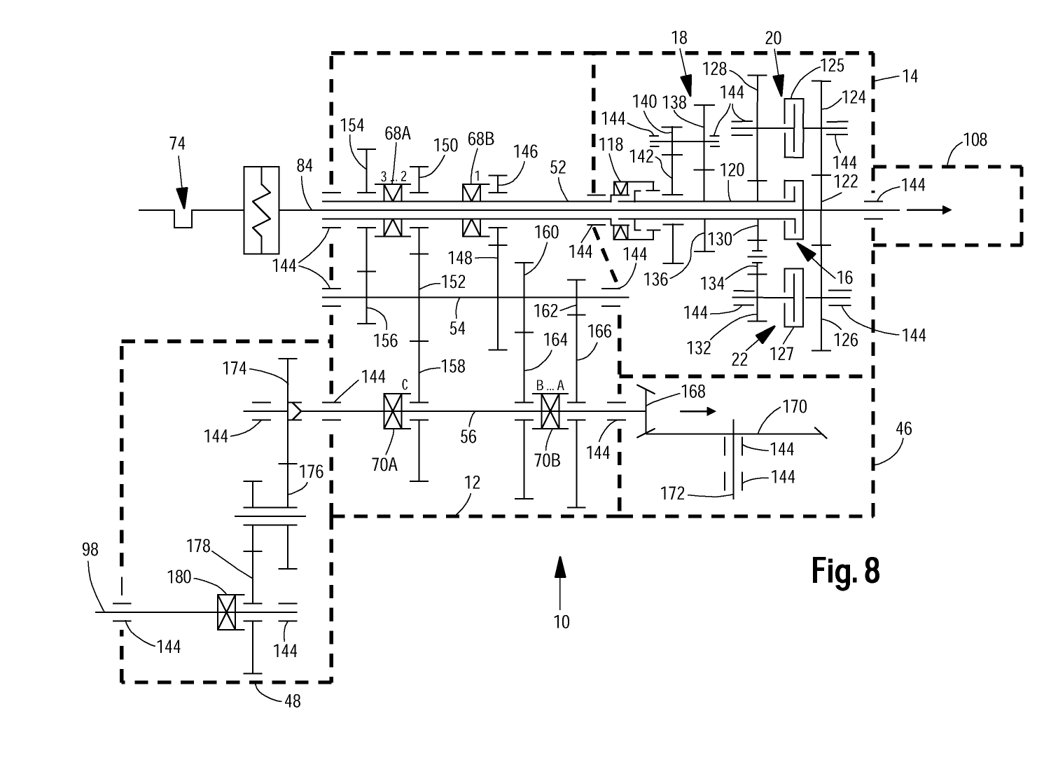

FIG. 7 shows a perspective view of a plurality of housing parts, which are assembled on one another, of option units of the option transmission module in a third stage of expansion,

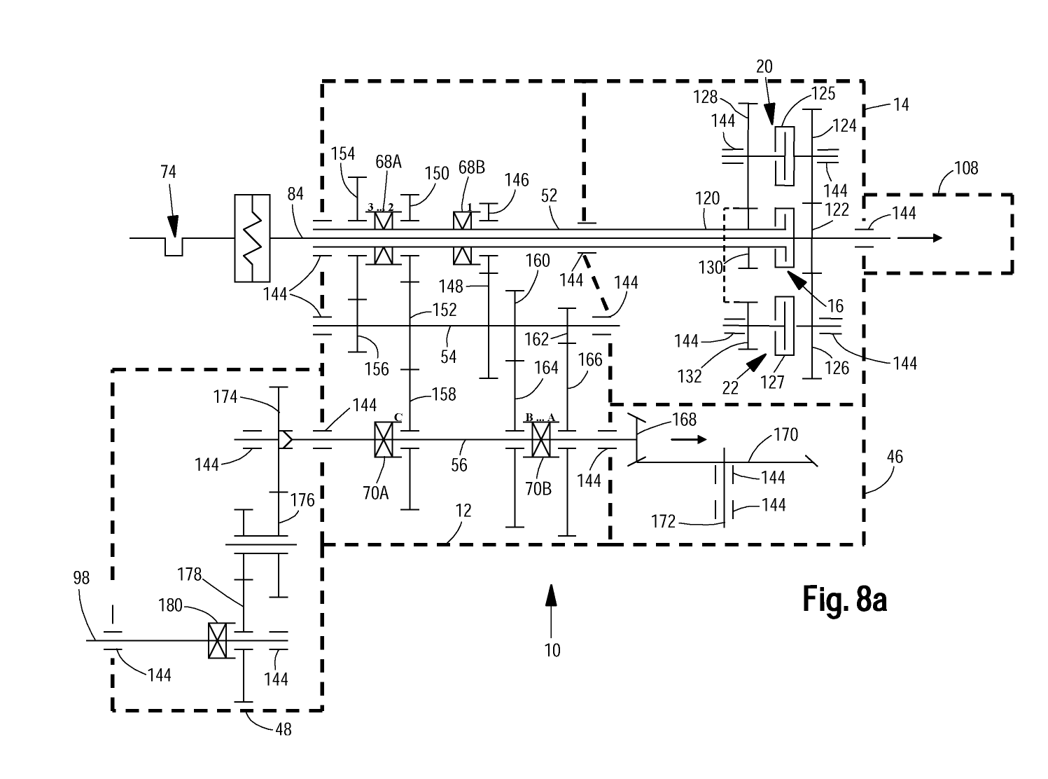

FIG. 8 shows a stick diagram of an exemplary embodiment of a transmission according to the invention having a main transmission unit and an option transmission module in each case in one stage of expansion,

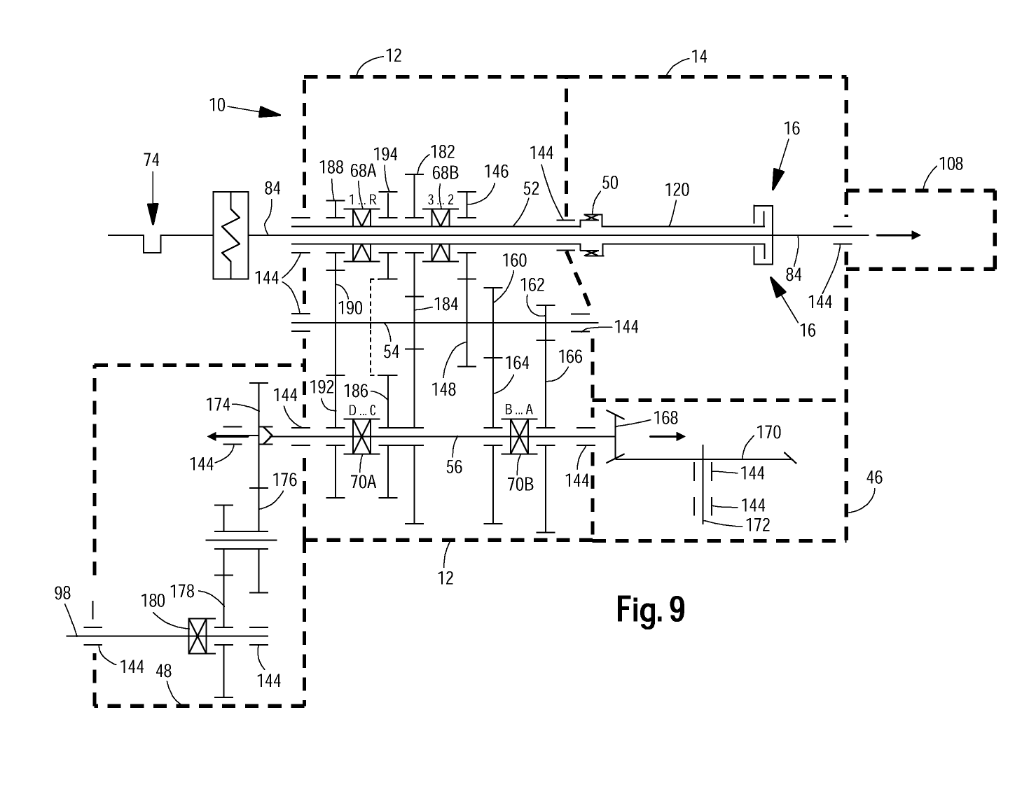

FIG. 9 shows a stick diagram of a further exemplary embodiment of a transmission according to the invention having a main transmission unit and an option transmission module in each case in another stage of expansion,

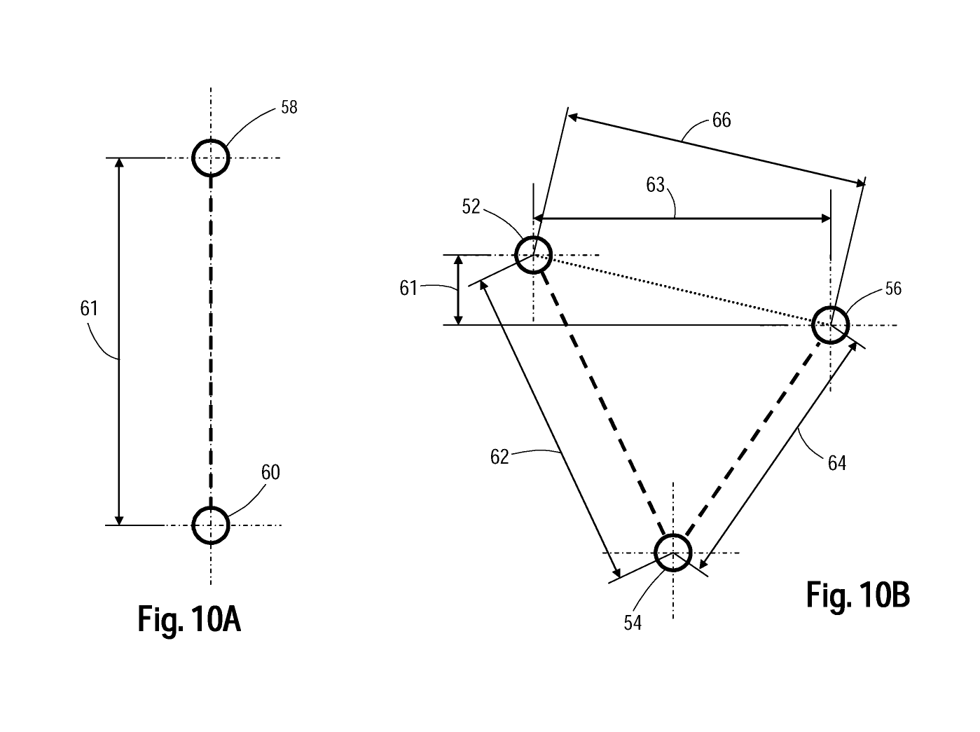

FIG. 10A is a schematic illustration of a configuration, which is known from the prior art, with regard to an input shaft and an output shaft of a transmission in a state installed in a vehicle,

FIG. 10B is a schematic illustration of a configuration with regard to an input shaft and an output shaft of a transmission according to the invention in a state installed in a vehicle,

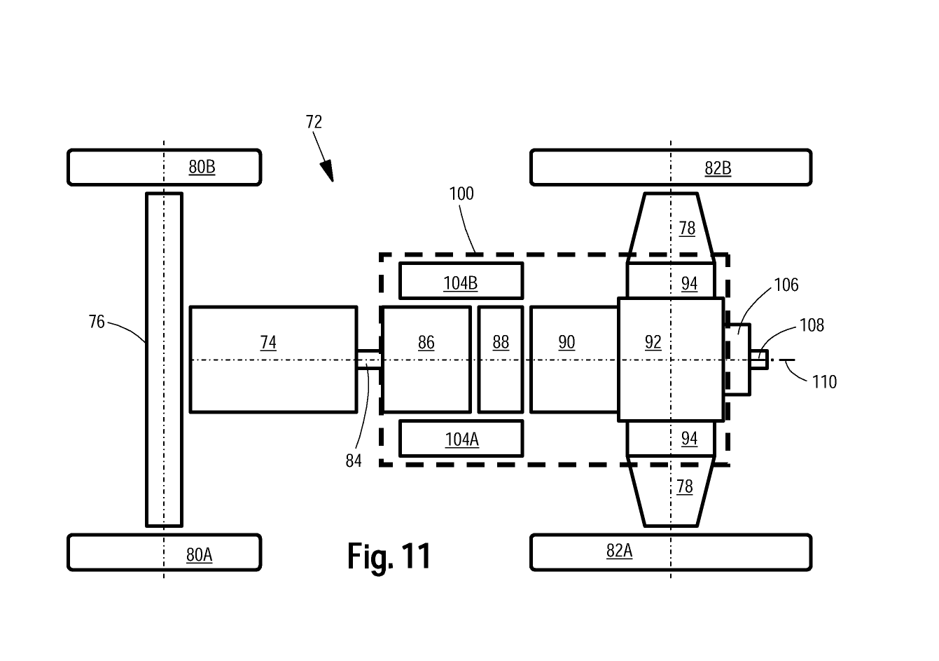

FIG. 11 is a schematic illustration of a plan view of a vehicle configuration having a transmission which is known from the prior art,

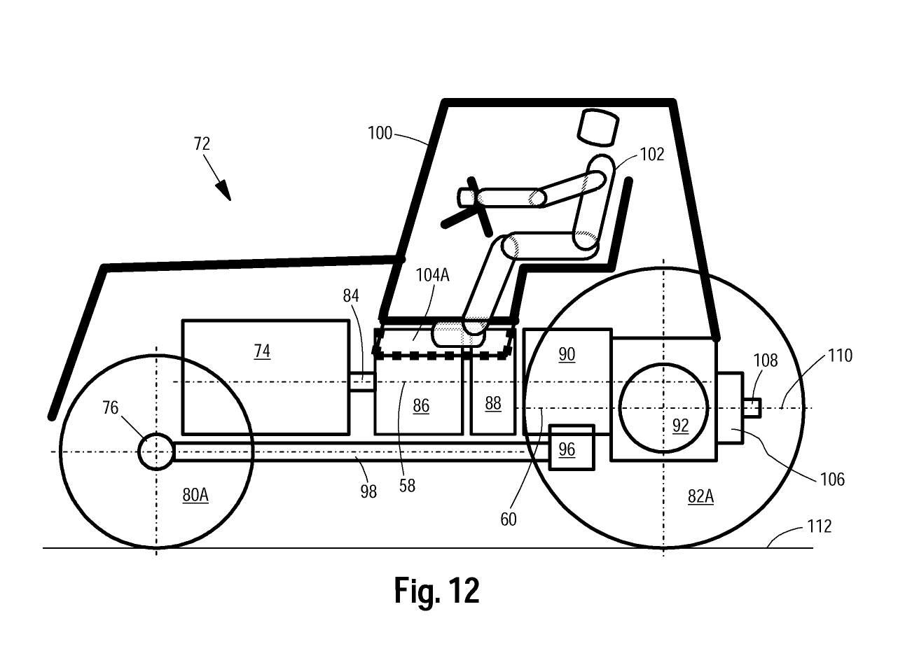

FIG. 12 is a schematic illustration of a side view of the vehicle configuration from FIG. 11,

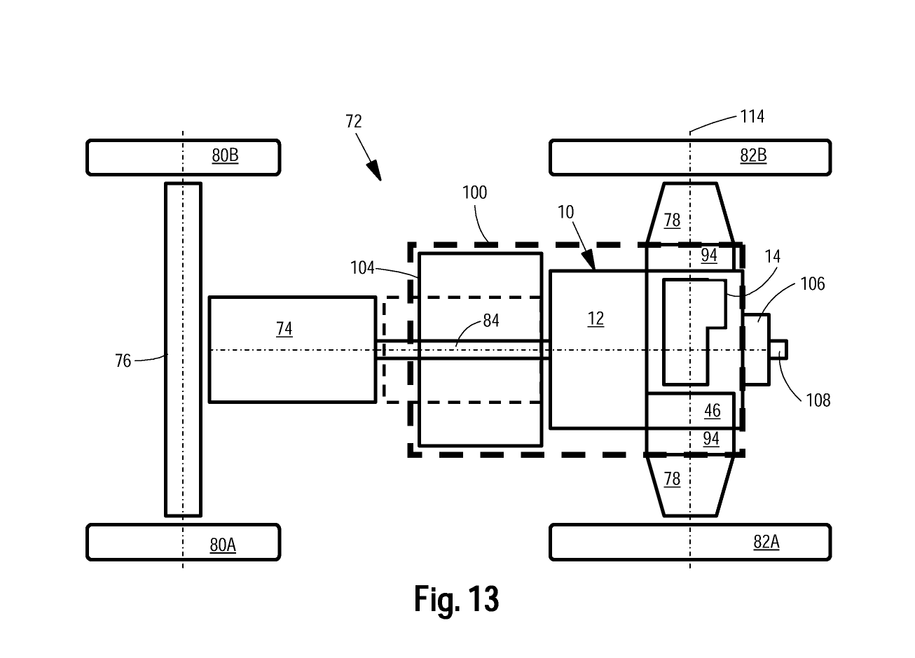

FIG. 13 is a schematic illustration of a plan view of a vehicle configuration having a transmission according to the invention,

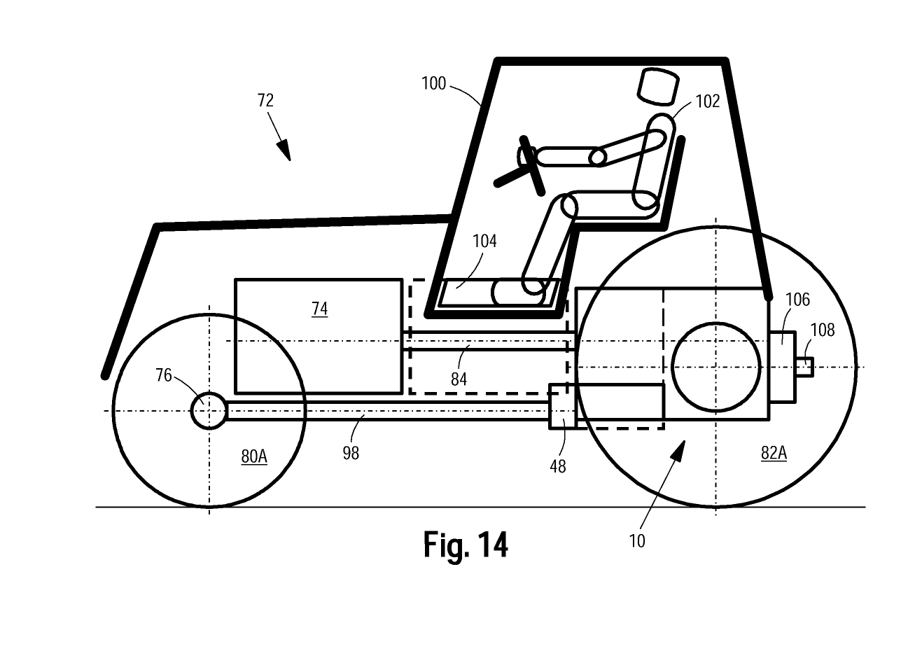

FIG. 14 is a schematic illustration of a side view of the vehicle configuration from FIG. 13, and

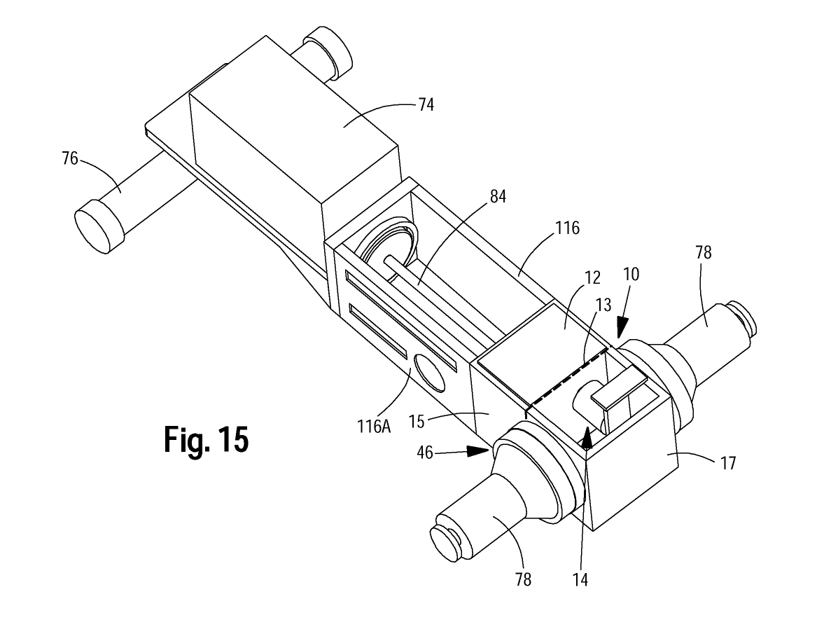

FIG. 15 is a schematic illustration of a perspective view of the vehicle configuration from FIGS. 13 and 14.

Identical or similar components or modular units are denoted by the same reference symbols in the figures.

FIGS. 1 and 2 show the same transmission 10 in a perspective view, specifically in FIG. 1 without a transmission housing and in FIG. 2 with a transmission housing 11. The transmission 10 comprises at least one main transmission unit 12, which can function independently, and an option transmission module 14 which can be adapted onto the main transmission unit 12. The main transmission unit 12 has a gear transmission and an auxiliary-range transmission, which is discussed in more detail later. It is possible by means of the option transmission module 14 to expand the functionality of the transmission 10, for example with the functionality of a clutch unit 16, a creep gear unit 18 and a two-stage transmission unit (High-Low) 20. The transmission 10 serves to transmit a torque generated by a drive engine to at least one drive axle of an agricultural utility vehicle, and in particular of a tractor, with neither the drive engine nor the drive axle being shown in FIGS. 1 and 2.

According to the invention, the main transmission unit 12 and the option transmission module 14 are designed in such a way that the installation space provided for the transmission 10 is substantially unchanged even if the option transmission module 14 is adapted onto the main transmission unit 12. Regardless of the embodiment or stage of expansion of the option transmission module 14, a predefinable maximum installation space of the transmission 10, formed from the option transmission module 14 and the main transmission unit 12, is not exceeded. In said embodiment, this is achieved in that the option transmission module 14 is always arranged spatially on or in the same predefined partial region of the transmission 10. Accordingly, the main transmission unit 12 is designed in such a way that it always makes available the installation space for the option transmission module 14. The installation space for the option transmission module 14 is always provided at the same point in the transmission housing 11, specifically independently of the stage of expansion of the option transmission module 14. FIG. 3 indicates, with the borders drawn in dashed lines, which components in said plan view belong to the main transmission unit 12 and which components belong to the option transmission module 14. The transmission housing 11 can be of single-part design. The transmission housing 11 could however also be of two-part or multi-part design. It is thus for example indicated by the dashed line 13 in each case in FIGS. 2, 4 and 15 that the transmission housing 11 can be composed here of two housing parts 15 and 17. Fastening elements for fastening the two housing parts 15 and 17 to one another, such as for example screws, are not shown in FIGS. 2, 4 and 15.

In FIGS. 1 to 4, the option transmission module 4 has four option units, specifically a clutch unit 16, a creep gear unit 18, a two-stage transmission unit (High-Low) 20 and a reversing unit 22. The two-stage transmission unit (High-Low) 20 is designed in such a way that it can be shifted in a force-fitting manner—including under load. FIGS. 3 and 4 also show a clutch 23 for the power take-off shaft gearing.

Both the option transmission module 14 shown in FIGS. 1 and 2 and also that shown in FIGS. 3 and 4 has a base housing part 24. At least the clutch unit 16 can be adapted onto said base housing part 24. FIG. 5 shows, in a perspective view, a base housing part 24 onto which only one clutch unit 16—not shown in FIG. 5—can be adapted. Said base housing part 24 is thus embodied merely as shown in FIG. 5 if no further option unit of the option transmission module 14 is provided in addition to a clutch unit 16.

In order that the option transmission module 14 is arranged or positioned on the transmission housing 11, in a suitable relative position in relation to the main transmission unit 12, the base housing part 24 of the option transmission module 14 has a plurality of positioning means 26. A plurality of further positioning means 28 which are of complementary design to the positioning means 26 are provided on the main transmission unit 12 or on the transmission housing 11, which further positioning means 28 are designed in each case in the form of a blind hole. Accordingly, that part of a positioning means 26 which is inserted into the blind hole is substantially in the form of a pin. The positioning means 26 and the further positioning means 28 are arranged in such a way that the option transmission module 14 can be positioned, with regard to its spatial position and orientation, relative to the main transmission unit 12 when the positioning means 26, 28 come into contact with one another. The positioning means 26, 28 have in each case a common stop face 30, 32. The stop face 30 is the lower face, which is hidden in FIGS. 1 to 5, of the base housing part 24. The stop face 32 is that face, which is shown in FIGS. 2 and 4, of the transmission housing 11 onto which a transmission lid (not shown in FIGS. 2 and 4) is adapted. The option transmission module 14 can therefore very particularly advantageously be adapted and adjusted onto the main transmission unit 12 by virtue of the option transmission module 14 initially being inserted from above into the opening 34, which is provided for this purpose, of the transmission housing 11. A shaft/hub connection is then produced between the main transmission unit 12 and the option transmission module 14, and the stop faces 30, 32 of the base housing part 24 and of the transmission housing 11 come into contact with one another. The positioning means 26 is inserted into the further positioning means 28. The option transmission module 14 is hereby positioned relative to the main transmission unit 12.

The option unit or the clutch unit 16 of the option transmission module 14 from FIGS. 3 and 4 has a (base) housing part 24 which serves to rotatably mount a shaft (not visible in FIGS. 3 and 4). Shown in the housing part 24 shown in FIG. 5 is the bearing 36A for the shaft (likewise not shown in FIG. 5) of the corresponding option unit. The housing part 24 has a transmission oil port 38 which is connected to a transmission lid (not shown in FIGS. 3 and 4) of the transmission housing 11. The housing part 24 accordingly comprises a transmission oil duct which runs therein and via which the hydraulic shift element for the clutch unit 16 can be actuated and/or via which the shaft of the clutch unit 16 can be lubricated.

Different options of the option transmission module 14 can be constituted by means of a modular, cumulative adaptation of a plurality of option units together with housing parts. For this purpose, the housing parts are designed in such a way that they can be mounted on one another. This can be seen for example in FIGS. 6 and 7. Here, a further housing part 40 is in each case mounted on the base housing part 24 from FIG. 6. FIG. 6 shows, in addition to the housing parts 24, 40, a further housing part 44 of an option transmission module 14 which has the clutch unit 16, creep gear unit 18 and two-stage transmission unit (High-Low) 20 option units. The creep gear unit 18 is arranged between the housing part 44 and the housing part 40. The bearing points 37A and 37B are provided for the shaft for said creep gear unit 18. The bearing points 36A and 36B are provided for the shaft of the clutch unit 16. The clutch unit 16 and the two-stage transmission unit (High-Low) 20 are arranged between the housing part 40 and the housing part 24, see for example FIG. 1. The bearing points 39A and 39B are provided for the shaft of the two-stage transmission unit 20, with the bearing points 39B being arranged in the housing part 40 and not being visible in this perspective view. The housing part 40 also has a bearing point 36B. FIG. 7 shows, in addition to the housing parts 24, 40 and 44 shown in FIG. 6, a further housing part 42. The reversing unit 22 is arranged between the housing part 42 and the base housing part 24, see for example FIGS. 1 to 4. The bearing point 39A of the base housing part 24 and the bearing point 39C of the housing part 42 are provided for the shaft of the reversing unit 22.

It is therefore possible to provide differently designed option transmission modules 14 by virtue of corresponding housing parts 24, 40, 44 together with corresponding option units being mounted on one another and subsequently inserted into the transmission housing 11 of the transmission 10 and operatively connected to the main transmission unit 12. The functionality of the option transmission module can advantageously be expanded in this way.

As already indicated, the transmission housing 11 accommodates the main transmission unit 12, see for example FIGS. 3 and 4. The transmission housing 11 is designed in such a way that the option transmission module 14 can be at least largely mounted in the transmission housing 11. A torque flow can be indirectly produced between the option transmission module 14 and the main transmission unit 12 by means of the clutch unit 16.

The rear axle differential gearing 46 can be adapted onto or into the transmission housing 11. In the exemplary embodiments shown in FIGS. 2 and 4, the rear axle differential gearing 46 is accommodated almost entirely in the transmission housing 11, with the rear axle differential gearing 46 being arranged at the left-hand side in the direction of travel of the tractor (not shown in FIGS. 1 to 4), and not centrally with regard to the rear axle as is conventional. It can be seen from FIG. 2 that an interface 48 for a mechanical individual wheel drive of the front axle of the tractor can be adapted.

Like the main transmission unit 12, the option transmission module 14 is also designed in the form of a transmission which is self-contained or can function independently. The option transmission module 14 is provided with separate actuating devices—in particular for actuating clutches of the option transmission modules 14 by means of hydraulic shift elements—which are not visible in FIGS. 1 to 4 but can be shifted with pressurized transmission oil via the transmission oil ports 38.

The option transmission module 14 can be reversibly adapted onto the main transmission unit 12 by means of a shaft/hub connection 50. The shaft/hub connection 50 is merely indicated in FIGS. 1, 3 and 4 and is designed to be torque-resistant in a form-fitting manner, with the option transmission module 14 having a shaft with an outer toothing, and with the shaft, which can be adapted thereon, of the main transmission unit 12 having a hollow shaft section with an inner toothing.

The option transmission module 14 can be reversibly adapted into or onto the main transmission unit 12, with it also being possible for the option transmission module 14 to be retrospectively removed from the main transmission unit 12 in order, for example for servicing purposes, to service other components in the transmission housing 11 or to retrospectively install an option transmission module 14 having other option units into the transmission 10.

The main transmission unit 12 is embodied as a three-shaft transmission. The three transmission shafts 52, 54 and 56 are arranged parallel to one another in the main transmission unit 12. Said transmission shafts are the input shaft 52, the intermediate shaft 54 and the output shaft 56. The input shaft 52 of the main transmission unit 12 is designed in the form of a hollow shaft.

FIG. 10A shows, in a sectioned view transversely with respect to the transmission shafts 58, 60, the conventional configuration of a transmission of a tractor which has an input shaft 58 and an output shaft 60. According to said configuration, the input shaft 58 is arranged directly above the output shaft 60 in the vertical direction. A transmission of said type is accordingly of relatively high construction and, for this purpose, relatively narrow.

FIG. 10B shows, in a sectioned view in a plane transversely with respect to the transmission shafts 52, 54 and 58 of the main transmission unit 12, the spatial arrangement of said transmission shafts in relation to one another. Accordingly, the main transmission unit 12 is configured in such a way that, in a state in which the main transmission unit 12 or transmission 10 is installed in a vehicle, the position of the output shaft 56 is arranged so as to be offset in the horizontal direction and in the vertical direction in relation to the position of the input shaft 52. In addition, the position of the intermediate shaft 54 is arranged so as to be offset in the vertical direction in relation to the position of the output shaft 56 and to the position of the input shaft 52. The position of the intermediate shaft 54 is arranged so as to be offset in the horizontal direction in relation to the position of the input shaft 52 and to the position of the output shaft 56. It can accordingly be gathered from FIG. 10B that at least the main transmission unit 12 of the transmission 10 according to the invention has, as viewed in the vertical direction, a smaller spacing 61 between the input shaft 52 and the output shaft 56 than is the case in a transmission from the prior art as per FIG. 10A. The main transmission unit 12 is accordingly not necessarily of as high a construction in the vertical direction as a transmission known from the prior art whose input shaft 58 and output shaft 60 are situated directly above one another (see FIG. 10A). Since the input shaft 52 and the output shaft 56 have the spacing 63 in the horizontal direction, the main transmission unit 12 is of wider construction in the horizontal direction than a transmission, conventionally used for a tractor, which is known from the prior art (see for example FIG. 10A). The axis spacings 62, 64 and 66 between the three transmission shafts 52, 54, 56 have in each case different values, with the axis spacing between the input shaft 52 and the intermediate shaft 54 being denoted by the reference symbol 62. The axis spacing between the intermediate shaft 54 and the output shaft 56 is denoted by the reference symbol 64. The axis spacing between the output shaft 56 and the input shaft 52 is denoted by the reference symbol 66.

Different transmission power classes can be formed in that the axis spacing 62 between the input shaft 52 and the intermediate shaft 54 and the axis spacing 64 between the intermediate shaft 54 and the output shaft 56 are varied among different main transmission units 12, with the ratio of the two axis spacings 62, 64, on the one hand between the input shaft 52 and the intermediate shaft 54 and on the other hand between the intermediate shaft 54 and the output shaft 56, remaining substantially constant. It is possible for a transmission type series to be formed from different transmission power classes of said type.

It can be seen from FIGS. 1 and 3 that the input shaft 52 has two shift devices 68A, 68B. The output shaft 56 likewise has two shift devices 70A, 70B. The shift devices 68A, 68B, 70A, 70B are designed such that they can be shifted in a form-fitting, synchronized manner, that is to say have in each case one shift fork and a shift sleeve.

The shift devices 68A, 68B, 70A, 70B shown in FIGS. 1 to 4 are arranged in each case at the same position relative to the transmission housing 11 if the individual transmission shafts 52, 54, 56 of the main transmission unit 12 are equipped differently—for example with different gearwheels—for transmissions 10 of different properties. The bearing points (not visible in FIGS. 1 to 4) of the transmission shafts 52, 54, 56 of the main transmission unit 12 are arranged in each case at the same position on the transmission housing 11 even where the transmission shafts 52, 54, 56 of the main transmission unit 12 are equipped differently for transmissions 10 of different properties.

It is possible, as a function of the shift states of the provided shift devices 68A, 68B, 70A, 70B to produce a torque flow from the input shaft 52 to the output shaft 56 via the intermediate shaft 54, or from the input shaft 52 directly, to the output shaft 56.

The input shaft 52 has gearwheels and two shift devices 68A, 68B for the gear transmission of the tractor in which the transmission 10 is installed. The output shaft 56 has gearwheels and two shift devices 70A, 70B for the auxiliary-range transmission.

The transmission housing 11 of the main transmission unit 12 has a housing opening 34 which serves for mounting the option transmission module 14. In order to mount the option transmission module 14, the latter is inserted into the housing opening 34. The housing opening 34 is designed so as to interact with the option transmission module 14 in such a way that the option transmission module 14, in a state installed in the housing opening 34, can be displaced towards the main transmission unit 12 in order that a shaft/hub connection can be produced between the main transmission unit 12 and the option transmission module 14.

FIGS. 11 and 12 show, in a schematic illustration, a plan view or a side view of a transmission configuration as is known in a tractor from the prior art. The tractor 72 thus has an internal combustion engine 74, a front axle 76 and a rear axle 78. The front axle 76 is assigned two front wheels 80A, 80B and the rear axle 78 is assigned two rear wheels 82A, 82B. The torque generated by the internal combustion engine 74 is initially transmitted via the driveshaft 84 to the gear transmission 86. Connected downstream of the gear transmission 86 are an option transmission 88 and an auxiliary-range transmission 90. A torque is transmitted from the auxiliary-range transmission 90 to the rear wheels 82A, 82B via the rear axle differential gearing 92 and via the final drive with brake 94. It is however possible for torque to be transmitted to the front wheels 80A, 80B via the interface 96 for the mechanical front wheel drive and the associated driveshaft 98 if said drive is engaged.

The region of the driver's cab is denoted by the reference symbol 100, and the operator of the tractor 72 is denoted by the reference symbol 102. Since the input shaft 58 is arranged above the output shaft 60 in the vertical direction in a similar way to FIG. 10A, the transmission configurations 86, 88, 90 shown in FIGS. 11 and 12 are of relatively high construction, so that, for assuming a comfortable seating position for his legs and feet, the operator 102 in the cabin 100 ultimately only has available to him the foot space 104A and 104B, that is to say only to the left and to the right adjacent to the gear transmission 86 and the option transmission 88. The power take-off shaft gearing 106 having the power take-off shaft 108 is connected downstream of the rear axle differential gearing 92. The vertical spacing between the axis 110 of the power take-off shaft 108 and the underlying surface 112 is specified in a standard.

It can be seen from FIGS. 13, 14 and 15 that, with the transmission 10 according to the invention, it is very particularly advantageously possible to provide a vehicle configuration in which the operator is provided with free space for his legs and feet over the entire region 104 transversely with respect to the vehicle longitudinal axis. This is possible because the transmission 10 according to the invention is of more compact design at least with respect to the vehicle longitudinal direction than is the case in the transmission configuration known from the prior art as per FIGS. 11 and 12. It can be seen from FIGS. 13, 14 and in particular FIG. 15 that the driveshaft 84 runs between the internal combustion engine 74 and the transmission 10, but otherwise no further component of the transmission 10—aside from the driveshaft 98 for the mechanical front wheel drive—is provided between the internal combustion engine 74 and the transmission 10. It is accordingly very particularly advantageously possible for said installation space to be utilized for other vehicle components, for example for a fuel tank (not shown in FIGS. 13, 14 and 15). The internal combustion engine 74 is connected to the transmission 10 by means of two laterally arranged frame parts 116A, 116B.

It can be seen from FIGS. 13 and 15 that the main transmission unit 12 is arranged in the spatial vicinity of the rear axle 78 of the vehicle. The rear axle 78 or rear wheels 82A, 82B can be driven at the drive output side with the torque output with the by the main transmission unit 12 together with the adapted option transmission module 14. If the all-wheel drive is activated, the front axle 76 and the front wheels 80A, 80B can also be driven with the torque output by the transmission 10.

With regard to the longitudinal axis 114 of the rear axle 78 of the tractor 72, the option transmission module 14 is arranged spatially behind the rear axle differential gearing 46, though is not in a direct torque flow with the latter. The main transmission unit 12 with the option transmission module 14 are designed in such a way that, in a state in which the main transmission unit 12 is installed in a tractor 72, the option transmission module 14 is arranged spatially adjacent to the rear axle differential gearing 46. The option transmission module 14 is not in a direct torque flow with the rear axle differential gearing 46. The main transmission unit 12 is in a torque flow with the rear axle differential gearing 46.

It is thereby possible to realize a torque flow from the drive engine or from the internal combustion engine 74 to the drive axle(s) 78, 76 of the tractor 72 via the main transmission unit 12. In concrete terms, it is possible to realize a torque flow from the drive engine 74 to the drive axles 78, 76 of the tractor 72 via the option transmission module 14 and via the main transmission unit 12 and the rear axle differential gearing 46 in said sequence.

The rear axle differential gearing 46 is connected downstream of the main transmission unit 12 in spatial terms and with regard to the torque flow. It is possible by means of said rear axle differential gearing 46 for at least part of the power—torque or rotational speed—output by the main transmission unit 12 to be transmitted to the drive wheels 82A, 82B of the rear axle 78 and/or—if the front wheel drive is activated—to the drive wheels 80A, 80B of the front axle 76.

Provided with the interface for the mechanical front wheel drive 48 is a transmission interface, by means of which at least part of the power supplied to the main transmission unit 12 can be transmitted via the driveshaft 98 to the front axle 76 of the tractor 72. The front axle 76 of the tractor 72 can likewise have an axle differential gearing (not shown).

The interface for the mechanical front wheel drive 48 can be operated and is designed in such a way that the ratio of the torques which can be output to the rear axle 78 and to the front axle 76 is variable. The torques transmitted to the two drive axles 78, 76 are preferably substantially in a ratio of 60:40.

The main transmission unit 12 comprises a further mechanical interface for the power take-off shaft 108 for transmitting mechanical torque from the main transmission unit 12 or from the internal combustion engine 74 to a working implement—not shown in the figures—which can be adapted onto the tractor 72. The power take-off shaft gearing 106 is arranged at the mechanical interface for the power take-off shaft 108.

The driveshaft 84 provided between the option transmission module 14 and the internal combustion engine 74 is designed in the form of a torsion shaft. The torsion shaft is designed, with regard to its dimensions and with regard to its torsional properties, in such a way that at least the first or lowest natural frequency of the entire transmission 10 or drivetrain does not lie within the natural frequency range of the utilizable rotational speed band of the tractor 72.

It is possible to produce a torque flow between the internal combustion engine 74 and the main transmission unit 12 via the torsion shaft 84 by means of the clutch unit 16 of the option transmission module 14.

The main transmission unit 12 of the tractor 72 is therefore designed in such a way that the option transmission module 14 can be adapted onto the main transmission unit 12. Accordingly, the option transmission module 14 is designed in such a way that it can be adapted onto the main transmission unit 12.

FIG. 8 shows, in a stick diagram, an exemplary embodiment of a transmission 10 according to the invention which is of similar design to the transmission shown in FIGS. 1 and 2. The transmission 10 has a main transmission unit 12 with 9 forward and 3 reverse gears. An option transmission module 14, which has a clutch unit 16, a creep gear unit 18, a two-stage transmission unit (High-Low) 20 and a reversing unit 22, is adapted onto the transmission 10.

The torque generated by the internal combustion engine 74 is supplied firstly to the clutch unit 16 of the option transmission module 14 via the driveshaft 84. If the frictionally engaging clutch unit 16 is engaged and the shift point 118 of the creep gear unit 18 is in the left-hand engaged position, and a rotationally fixed connection is therefore produced between the output shaft 120 of the option transmission module 14 and the input shaft 52 of the main transmission unit 12, a torque is introduced into the main transmission unit 12. Both the output shaft 120 of the option transmission module 14 and the input shaft 52 of the main transmission unit 12 are embodied as hollow shafts. The gearwheel 122 is rotationally fixedly connected to the driveshaft 84 and meshes both with the input gearwheel 124 of the two-stage transmission unit 20 and with the input gearwheel 126 of the reversing unit 22. If the frictionally engaging clutch unit 125 of the two-stage transmission unit 20 is engaged, a rotationally fixed connection is produced between the input gearwheel 124 and the output gearwheel 128. The output gearwheel 128 meshes with the gearwheel 130 which is rotationally fixedly connected to the output shaft 120 of the option transmission module 14. If the frictionally engaging clutch unit 127 of the reversing unit 22 is engaged, a rotationally fixed connection is produced between the input gearwheel 126 and the intermediate gearwheel 132. The intermediate gearwheel 132 meshes with an output gearwheel 134 of the reversing unit 22. The output gearwheel 134 in turn meshes with the gearwheel 130. A torque is thereby transmitted from the driveshaft 84 to the input shaft 52 of the main transmission 12 via the option transmission module 14 either if the clutch unit 16 is engaged or if the clutch unit 125 of the two-stage transmission unit 20 is engaged or if the clutch unit 127 of the reversing unit 22 is engaged, with it being possible for always only one clutch unit 16, 125 or 127 to be engaged.

The gearwheel 136 is likewise rotationally fixedly connected to the output shaft 120 of the option transmission module 14 and meshes with the input gearwheel 138 of the creep gear unit 18. Rotationally fixedly connected to the input gearwheel 138 is the gearwheel 140 which meshes with the output gearwheel 142 of the creep gear unit 18. If the clutch unit 16 or the clutch unit 125 of the two-stage transmission unit 20 or the clutch unit 127 of the reversing unit 22 is engaged and the shift point 118 is situated in its right-hand engaged position, a torque is likewise transmitted to the input shaft 52 of the main transmission unit 12 via the output shaft 120, the gearwheel 136, the input gearwheel 138, the gearwheel 140, the output gearwheel 142 of the creep gear unit 18 and via the interface 118. The tractor 72 is then in the creep gear mode.

The reference symbol 144 denotes the bearing points in the transmission housing 11 or in the housing parts 24, 40, 42, 44 of the individual shafts.

The torque introduced into the main transmission unit 12 via the input shaft 52 is transmitted to the gearwheel 146 if the shift point 68B is engaged. In said state, the first gear of the gear transmission is selected. The gearwheel 146 meshes with the gearwheel 148 which is rotationally fixedly connected to the intermediate shaft 54. If the shift point 68B is not in the engaged position and the shift point 68A is in the right-hand engaged position, the input shaft 52 is rotationally fixedly connected to the gearwheel 150. In said state, the second gear of the gear transmission is selected. The gearwheel 150 meshes with the gearwheel 152 which is likewise rotationally fixedly connected to the intermediate shaft 54 of the main transmission unit 12. If the shift point 68B is not in the engaged position and the shift point 68A is in the left-hand engaged position, the input shaft 52 is rotationally fixedly connected to the gearwheel 154. In said state, the third gear of the gear transmission is selected. The gearwheel 154 meshes with the gearwheel 156 which is likewise rotationally fixedly connected to the intermediate shaft 54 of the main transmission unit 12. If, therefore, one of the two shift points 68A, 68B is in an engaged position, the intermediate shaft 54 is rotated either via the gearwheel 148 or the gearwheel 152 or the gearwheel 156.

The gearwheel 158 meshes with the gearwheel 152. The gearwheels 160, 162 are rotationally fixedly connected to the intermediate shaft 54. The gearwheel 164 meshes with the gearwheel 160. The gearwheel 166 meshes with the gearwheel 162. Accordingly, the gearwheels 158, 164 and 166 rotate if the intermediate shaft 54 is rotated. If the shift point 70B is in the right-hand engaged position, a torque flow is produced between the intermediate shaft 54 and the gearwheels 162, 166 to the output shaft 56. In said state, the group A of the transmission 10 of the tractor 72 is selected. If the shift point 70B is in the left-hand engaged position, a torque flow is produced between the intermediate shaft 54 and the gearwheels 160, 164 to the output shaft 56. In said state, the group B of the transmission 10 of the tractor 72 is selected. If the shift point 70A is in the engaged position, a torque flow is produced between the intermediate shaft 54 and the gearwheels 152, 158 to the output shaft 56. In said state, the group C of the transmission 10 of the tractor 72 is selected.

If the output shaft 56 of the main transmission unit 12 is rotated, the gearwheel 170 of the differential gearing 46 is rotated via the bevel gearwheel 168, so that the drive output shaft 172 which is connected to the wheels 82A, 82B is likewise rotated and the tractor 72 is thereby driven.

Provided in the front region of the transmission 10 is the interface 48 for the mechanical front wheel drive. Rotationally fixedly connected to the output shaft 56 of the main transmission unit 12 is the gearwheel 174 which meshes with the right-hand gearwheel of the double gearwheel 176. The left-hand gearwheel of the double gearwheel 176 meshes with the gearwheel 178. If the shift point 180 of the interface 48 for the mechanical front wheel drive is in the engaged position, a torque flow is produced from the output shaft 56 of the main transmission unit 12 via the gearwheels 174, 176, 178 to the driveshaft 98 for the wheels 80A, 80B of the front axle 76.

The transmission 10 shown in FIG. 8 therefore has three gears and three groups with the main transmission unit 12. The option transmission module 14 comprises, in addition to the clutch unit 16, the creep gear unit 18, the two-stage transmission unit 20 and the reversing unit 22. In addition, the interface 48 for the front wheel drive is installed on the transmission 10.

FIG. 8a shows an exemplary embodiment of a transmission 10 according to the invention which is changed from that of FIG. 8, with the change relating to the option transmission module 14. In FIG. 8a, too, the option transmission module 14 has a clutch unit 16, a two-stage transmission unit 20 and a reversing unit 22. The gearwheel 130 which is rotationally fixedly connected to the hollow shaft 120 meshes with the intermediate gearwheel 132. If the clutch unit 125 of the two-stage transmission unit 20 and the clutch unit 16 are not engaged and the clutch unit 127 of the reversing unit 22 is engaged, torque is transmitted from the driveshaft 84 via the reversing unit 22 to the hollow shaft 120 and therefore to the main transmission unit 12. The functioning of the transmission 10 shown in FIG. 8a is otherwise substantially similar to the functioning of the transmission shown in FIG. 8.

FIG. 9 shows a further exemplary embodiment of a transmission 10 according to the invention which has 12 forward and 4 reverse gears with three gears and four groups with the main transmission unit 12 provided there. Where components or modular units of the transmission from FIG. 8 are also provided or shown in FIG. 9, said components or modular units are denoted by the same reference symbols. In the transmission 10 shown in FIG. 9, the option transmission module 14 comprises merely the clutch unit 16 (that is to say the lowest stage of expansion of the exemplary embodiment) which can, in a frictionally engaging or force-fitting manner, produce a torque flow from the driveshaft 84 via the output shaft 120 of the option transmission module 14 to the input shaft 52 of the main transmission unit 12. In addition, the shaft/hub connection 50 between the option transmission module 14 and the main transmission unit 12 is shown.

The main transmission unit 12 shown in FIG. 9 differs from that of FIG. 8 substantially by the three gearwheel chains 182 to 194, arranged at the left-hand side, which are discussed in more detail in the following. The shift point 68B now has two different positions, specifically a right-hand engaged position, as was substantially also provided in FIG. 8. Said position corresponds to the second gear of the main transmission unit 12. Added to this is a left-hand engaged position in which a torque flow can be produced between the input shaft 52 of the main transmission unit 12 and the gearwheel 182. The left-hand engaged position of the shift point 68B corresponds to the third gear of the main transmission unit 12. The gearwheel 182 meshes with the gearwheel 184 which is rotationally fixedly connected to the intermediate shaft 54. The gearwheel 184 meshes with the double gearwheel 186 which is mounted so as to be rotatable about the output shaft 56 of the main transmission unit 12. If the shift point 68A is in the left-hand engaged position, a torque flow is produced between the input shaft 52 of the main transmission unit 12 and the gearwheel 188. The left-hand engaged position of the shift point 68A corresponds to the first gear of the main transmission unit 12. The gearwheel 188 meshes with the gearwheel 190 which is rotationally fixedly connected to the intermediate shaft 54. The gearwheel 190 meshes with the gearwheel 192 which is mounted so as to be rotatable about the output shaft 56 of the main transmission unit 12. If the shift point 68A is in the right-hand engaged position, a torque flow is produced between the input shaft 52 of the main transmission unit 12 and the gearwheel 194. The right-hand engaged position of the shift point 68A corresponds to the reverse gear of the main transmission unit 12. The gearwheel 194 meshes with the left-hand part of the double gearwheel 186 (indicated by the dashed line) which is mounted so as to be rotatable about the output shaft 56 of the main transmission unit 12. It is thereby possible to shift three forward gears and one reverse gear on the input shaft 52.

The shift points 70A, 70B shift not only the three groups A, B and C shown in FIG. 8 but also a fourth group D if the shift point 70A is in the left-hand engaged position. The functioning of the two shift points 70A, 70B and the transmission to the rear axle differential gearing 46 or to the interface 48 for the mechanical front wheel drive is otherwise similar to that from FIG. 8.

It is clear from the differently configured transmissions 10 shown, in FIGS. 8 and 9 that a transmission type series—in particular for an agricultural or industrial utility vehicle, and in concrete terms, for a tractor 72—can be formed and also advantageously provided economically by adapting different option transmission modules 14 onto in each case one main transmission unit 12. It is thus for example possible for the main transmission unit 12 from FIG. 8 to be combined either with the option transmission module 14 from FIG. 8 or with the option transmission module 12 from FIG. 9. As an alternative or in addition, different transmissions 10 can be formed in that the main transmission units 12 are in each case designed differently, with it being possible for the transmission 10 to have the same or else a different option transmission module 14. It is thus for example possible for the main transmission unit 12 from FIG. 8 or the main transmission unit 12 from FIG. 9 to be combined with the option transmission module 14 from FIG. 8.

As can be seen by comparing FIGS. 8 and 9, the main transmission unit 12 can be designed differently in that the input shaft 52, the intermediate shaft 54 and/or the output shaft 56 can be equipped with different gearwheels. Where the individual transmission shafts 52, 54, 56 of the main transmission unit 12 are equipped differently, the corresponding shift devices 68A, 68B, 70A, 70B are, in said exemplary embodiments, arranged in each case at the same point or position. It is also the case in said exemplary embodiments that, where main transmission units 12 are designed differently, the bearing points 144 of the transmission shafts 52, 54, 56 are arranged in each case at the same point/position even where the transmission shafts 52, 54, 56 of the main transmission unit 12 are equipped differently. It is therefore possible to always use the same transmission housing 11 and the same shift devices 68A, 68B, 70A, 70B with different main transmission units 12.

It is finally to be pointed out very specifically that the exemplary embodiments discussed above merely serve to describe the claimed teaching, but do not restrict said teaching to the exemplary embodiments.

1. Transmission for transmitting a torque generated by a drive engine (72) to at least one drive axle (78, 76) of a vehicle (72), in particular an agricultural or industrial utility vehicle, having at least one main transmission unit (12) which can function independently, with the main transmission unit (12) having a gear transmission and/or an auxiliary-range transmission, with it being possible for an option transmission module (14) to be adapted onto the main transmission unit (12), and with it being possible by means of the option transmission module (14) to expand the functionality of the transmission (10), characterized in that the main transmission unit (12) and the option transmission module (14) are designed in such a way that the installation space provided for the transmission (10) is substantially unchanged even if the option transmission module (14) is adapted onto the main transmission unit (12).

2. Transmission according to claim 1, characterized in that the option transmission module (14) has at least one option unit, with it being possible for an option unit to be designed in the form of at least one clutch unit (16) and/or a reversing unit (22) and/or a creep gear unit (18) and/or a two-stage transmission unit (High-Low) (20).

3. Transmission according to claim 2, characterized in that the two-stage transmission unit (High-Low) (20) is designed such that it can be shifted in a form-fitting or force-fitting manner—in particular under load.

4. Transmission according to one of claims 1 to 3, characterized in that the option transmission module (14) has a base housing part (24) onto which at least one option unit—in particular the clutch unit (16)—can be adapted.

5. Transmission according to claim 4, characterized in that the base housing part (24) of the option transmission module (14) has at least one positioning means (26, 30), in that a further positioning means (28, 32), which is of substantially complementary design to the positioning means (26, 30), is provided on the main transmission unit (12) and/or on a transmission housing (11), in that the positioning means (26, 30) and the further positioning means (28, 32) are arranged in such a way that the option transmission module (14) can be positioned, with regard to its spatial position and/or orientation, relative to the main transmission unit (12) when the positioning means (26, 28, 30, 32) come into contact with one another, and in that the positioning means (26) preferably has at least one pin, at least one stop face (30, 32) and/or at least one edge.

6. Transmission according to one of claims 2 to 5, characterized in that an option unit of the option transmission module (14) has a housing part (24, 40, 42, 44), in that the housing part (24, 40, 42, 44) serves to rotatably mount at least one shaft, in that the housing part (24, 40, 42, 44) can have a bearing support, in that the housing part (24, 40, 42, 44) can form a transmission oil port (38) to a housing wall and/or to a transmission cover of the main transmission unit (12), and in that the housing part (24, 40, 42, 44) can have a duct via which a hydraulic shift element can be actuated.

7. Transmission according to claim 6, characterized in that different options of the option transmission module (14) can be constituted by means of a modular, cumulative adaptation of a plurality of option units together with housing parts (24, 40, 42, 44) or bearing supports, preferably by virtue of the housing parts (24, 40, 42, 44) being mounted on one another, whereby in particular the functionality of the option transmission module (14) can be expanded, and/or by virtue of transmission shafts of individual option units being arranged substantially coaxially or parallel to one another.

8. Transmission according to one of claims 1 to 7, characterized by a single-part or multi-part transmission housing (11) which holds the main transmission unit (12), with the transmission housing (11) being designed in such a way that the option transmission module (14) can be at least largely mounted in the transmission housing (11), and with it being possible to produce a torque flow indirectly or directly between the option transmission module (14) and the main transmission unit (12).

9. Transmission according to claim 8, characterized in that a pump drive for transmission oil, a rear axle differential gearing (46), an interface for a mechanical individual wheel drive (48) and/or an intermediate axle differential gearing can be adapted into or onto the transmission housing (11).

10. Transmission according to one of claims 1 to 9, characterized in that the option transmission module (14) is designed in the form of a transmission which is self-contained or can function independently and which has, for example, a separate oil pump and/or at least one separate actuating device—for example for actuating clutches of the option transmission module (14) by means of hydraulic shift elements, and in that the option transmission module (14) can have a largely closed-off option transmission module housing.

11. Transmission according to one of claims 1 to 10, characterized in that the option transmission module (14) can be adapted onto the main transmission unit (12)—preferably in a reversible fashion—by means of a shaft/hub connection (50), with the shaft/hub connection (50) being designed to be torque-resistant in a form-fitting or force-fitting manner.

12. Transmission according to one of claims 1 to 11, characterized in that the option transmission module (14) can be adapted in a reversible fashion into or onto the main transmission unit (12), and in that the option transmission module (14) can preferably be retrospectively removed from the main transmission unit (12).

13. Transmission according to one of claims 1 to 12, characterized in that the main transmission unit is embodied as a three-shaft transmission, and in that the three transmission shafts (52, 54, 56) are arranged substantially parallel to one another in the main transmission unit (12).

14. Transmission according to claim 13, characterized in that the main transmission unit (12) has an input shaft (52)—preferably designed in the form of a hollow shaft—, an intermediate shaft (54) and an output shaft (56).

15. Transmission according to claim 13 or 14, characterized by a design which is such that, in a state in which the main transmission unit (12) is installed in a vehicle (72), the position of the output shaft (56) is arranged so as to be offset in the horizontal direction and if appropriate in the vertical direction in relation to the position of the input shaft (52).

16. Transmission according to one of claims 13 to 15, characterized by a design which is such that, in a state in which the main transmission unit (12) is installed in a vehicle (72), the position of the intermediate shaft (54) is arranged so as to be offset in the vertical direction in relation to the position of the output shaft (56) and/or to the position of the input shaft (52).

17. Transmission according to one of claims 13 to 16, characterized by a design which is such that, in a state in which the main transmission unit (12) is installed in a vehicle (72), the position of the intermediate shaft (54) is arranged so as to be offset in the horizontal direction in relation to the position of the input shaft (52) and/or to the position of the output shaft (56).

18. Transmission according to one of claims 13 to 17, characterized in that the input shaft (52) and/or the output shaft (56) has in each case at least one shift device (68A, 68B; 70A, 70B), and in that a shift device (68A, 68B; 70A, 70B) can be shifted in a preferably form-fitting, synchronized or unsynchronized manner.

19. Transmission according to one of claims 13 to 18, characterized in that it is possible, as a function of the shift states of the provided shift devices (68A, 68B, 70A, 70B), to produce a torque flow from the input shaft (52) to the output shaft (56) via the intermediate shaft (54), or from the input shaft (52) directly to the output shaft (56).

20. Transmission according to one of claims 1 to 19, characterized in that, where the individual transmission shafts (52, 54, 56) of the main transmission unit (12) are equipped differently for transmissions (10) with different properties, the corresponding shift devices (68A, 68B, 70A, 70B) are arranged in each case at the same position, and/or in that at least one bearing point (144) of a transmission shaft (52, 54, 56) are arranged in each case at the same position even where a main transmission unit (12) is equipped differently for transmissions (10) with different properties.

21. Transmission according to claim 19 or 20, characterized in that the input shaft (52) has gearwheels and at least one shift device (68A, 68B) for the gear transmission, and in that the output shaft (56) has gearwheels and at least one shift device (70A, 70B) for the auxiliary-range transmission.

22. Transmission according to one of claims 13 to 21, characterized in that all of the axis spacings between the three transmission shafts (52, 54, 56) have in each case substantially the same value, or in that at least two—preferably all three—axis spacings (62, 64, 66) between the three transmission shafts (52, 54, 56) have in each case different values.

23. Transmission according to one of claims 1 to 22, characterized in that the main transmission unit (12) has a housing opening (34) which serves for mounting the option transmission module (14), in that, for mounting, the option transmission module (14) can be inserted into the housing opening (34), and in that the housing opening (34) is preferably designed so as to interact with the option transmission module (14) in such a way that the option transmission module (14), in a state installed in the housing opening (34), can be displaced in at least one direction relative to the main transmission unit (12) in order to produce a shaft/hub connection (50) between the main transmission unit (12) and the option transmission module (14).

24. Transmission according to one of claims 1 to 23, characterized in that the main transmission unit (12) is arranged in the spatial surroundings/vicinity of a drive axle (78) of the vehicle (72), and in that it is possible for the drive axle (78) to be at least partially driven with the torque output at the drive output side by the main transmission unit (12) together with any option transmission module (14) which may be adapted.

25. Transmission according to claim 24, characterized in that, with regard to a longitudinal axis (114) of the drive axle (78) of the vehicle (72), the main transmission unit (12) and/or the option transmission module (14) is arranged spatially behind the axle differential gearing (46), though need not be in a direct torque flow with the latter.

26. Transmission according to one of claims 1 to 25, characterized in that the main transmission unit (12), together with any option transmission module (14) which may be provided, is or are designed in such a way that, in a state in which the main transmission unit (12) is installed in a vehicle (72), the option transmission module (14) is arranged spatially adjacent to the axle differential gearing (46), and in that the option transmission module (14) is preferably not in a direct torque flow with the axle differential gearing (46).

27. Transmission according to one of claims 1 to 26, characterized in that it is possible to realize a torque flow from the drive engine (74) to the drive axle (78, 76) of the vehicle (72) via the main transmission unit (12), and in that it is preferably possible to realize a torque flow from the drive engine (74) to the drive axle (78, 76) of the vehicle (72) via the option transmission module (14) and via the main transmission unit (12) in said sequence.

28. Transmission according to one of claims 1 to 27, characterized in that an axle differential gearing (48) is connected downstream of the main transmission unit (12), by means of which axle differential gearing (48) at least part of the power—torque or rotational speed—output by the main transmission unit (12) can be transmitted to the drive wheels (82A, 82B) of the corresponding drive axle (78).

29. Transmission according to one of claims 1 to 28, characterized in that a transmission interface (96) is provided, by means of which at least part of the power supplied to the main transmission unit (12) can be transmitted via a further drive output shaft (98) to a further drive axle (76) of the vehicle (72), with it being possible for the further drive axle (76) to likewise have an axle differential gearing.

30. Transmission according to claim 29, characterized in that the transmission interface (48, 96) can be operated and/or is designed in such a way that the ratio of the torques which can be output to the drive axle (78) and to the further drive axle (76) is variable, and in that the torques transmitted to the two drive axles (78, 76) are preferably substantially in a ratio of 60:40.

31. Transmission according to one of claims 1 to 30, characterized in that the main transmission unit (12) has a further mechanical interface—in particular a power take-off shaft (108)—for transmitting mechanical torque from the main transmission unit (12) and/or from the option transmission module (14) and/or from the drive engine (74) to a working implement which can be adapted onto the vehicle (72).

32. Transmission according to one of claims 1 to 31, characterized in that the main transmission unit (12) or the option transmission module (14) can be connected to the drive engine (74) by means of a torsion shaft (84) which is preferably designed, with regard to its dimensions or with regard to its properties, in such a way that at least one—preferably the first or lowest—natural frequency of the entire transmission (10) does not lie within the natural frequency range of the utilizable rotational speed band.

33. Transmission according to one of claims 1 to 32, characterized in that the main transmission unit (12) or the option transmission module (14) can be connected to the drive engine (74) by means of a driveshaft, with a torsion element preferably being provided between the main transmission unit (12) and the drive engine (74).

34. Transmission according to claim 32 or 33, characterized in that it is possible to produce a torque flow between the drive engine (74) and the main transmission unit (12) via the torsion shaft (84) or via the driveshaft by means of the clutch unit (16) of the option transmission module (14).

35. Transmission according to one of claims 1 to 34, characterized in that the gear transmission or the auxiliary-range transmission of the main transmission unit (12) is embodied as a power-shift transmission.

36. Main transmission unit for an agricultural or industrial utility vehicle, characterized by a design which is such that an option transmission module (14) according to one of claims 1 to 35 can be adapted onto the main transmission unit (12).

37. Option transmission module for a transmission for an agricultural or industrial utility vehicle, characterized by a design which is such that the option transmission module (14) can be adapted onto a main transmission unit (12) according to one of claims 1 to 35.

38. Transmission type series for an agricultural or industrial utility vehicle, in particular a tractor (72), with the transmission type series being formed from differently-designed transmissions (10) according to one of claims 1 to 35, characterized in that different transmissions (10) can be formed by adapting different option transmission modules (14) onto a main transmission unit (12) and/or in that different transmissions (10) can be formed in that the main transmission unit (12) can be designed differently.

39. Transmission type series according to claim 38, characterized in that the main transmission unit (12) can be designed differently in that the input shaft (52), the intermediate shaft (54) and/or the output shaft (56) can be equipped with different gearwheels, and in that, where the individual transmission shafts (52, 54, 56) of the main transmission unit (12) are equipped differently, the corresponding shift devices (68A, 68B, 70A, 70B) are preferably arranged in each case at the same position.

40. Transmission type series according to claim 38 or 39, characterized in that, where main transmission units (12) are designed differently, the bearing points of a transmission shaft (52, 54, 56) are arranged in each case at the same position even where a transmission shaft (52, 54, 56) of the main transmission unit (12) is equipped differently.

41. Transmission type series according to one of claims 38 to 40, characterized in that different transmission power classes can be formed in that the axis spacing (62) between the input shaft (52) and the intermediate shaft (54) and the axis spacing (64) between the intermediate shaft (54) and the output shaft (56) are varied among different main transmission units (12), with the ratio of the two axis spacings (62, 64), on the one hand between the input shaft (52) and the intermediate shaft (54) and on the other hand between the intermediate shaft (54) and the output shaft (56), remaining substantially constant.

42. Agricultural or industrial utility vehicle, in particular a tractor (72), characterized by a transmission (10) according to one of claims 1 to 35.

43. Method for producing a transmission according to one of claims 1 to 35, characterized in that the option transmission module (14) is mounted on the main transmission unit (12) of the transmission (10) in such a way that the option transmission module (14) is inserted into a housing opening (34) of the transmission housing (11) of the main transmission unit (12), in that the option transmission module (14) is displaced along at least one direction in such a way that a shaft/hub connection (50) is produced between the option transmission module (14) and the main transmission unit (12), and in that the option transmission module (14) is fixed to the main transmission unit (12), preferably to the housing (11) of the main transmission unit (12).

44. Method according to claim 43, characterized in that a plurality of option units (16, 18, 20, 22) are assembled to form an option transmission module (14) by virtue of in each case one option unit (18, 20, 22) being fastened with its base housing part (40, 42, 44) to a base housing part (24) of another option unit (16, 18, 20, 22).
